(19) United States
(12) Patent Application Publication
(10) Pub. No.: US 2023/0376847 A1
(43) Pub. Date: Nov. 23, 2023

(54) Conversation Based Diagnosis and Troubleshooting of Maintenance Requests Using a Large Language Model Driven Chatbot

(71) Applicant: Mezo Inc., Chicago, IL (US)

(72) Inventors: Michael Travalini, Chicago, IL (US); John Botica, Boston, MA (US); Erin Karam, La Grange Park, IL (US); David Merritt Turner, Denver, CO (US)

(21) Appl. No.: 18/228,373

(22) Filed: Jul. 31, 2023

Related U.S. Application Data
(63) Continuation of application No. PCT/US23/61926, filed on Feb. 3, 2023.
Application No. PCT/US23/61926 is a continuation of application No. 18/105,424, filed on Feb. 3, 2023.
(60) Provisional application No. 63/357,682, filed on Jul. 1, 2022.
(60) Provisional application No. 63/306,794, filed on Feb. 4, 2022.
(60) Provisional application No. 63/357,682, filed on Jul. 1, 2022.
(60) Provisional application No. 63/306,794, filed on Feb. 4, 2022.

(51) Int. Cl. G06N 20/00; G06Q 10/20

(52) U.S. Cl. CPC G06N 20/00; G06Q 10/20

(57) ABSTRACT

Aspects of the disclosure relate to diagnosing and troubleshooting maintenance repair requests using an artificial intelligence-driven chatbot. In some embodiments, a computing platform may receive a maintenance request from a user and may configure a chatbot to extract details that describe an item to be repaired. The computing platform may configure the chatbot to communicate with the user and to generate, based on the communication, an enriched work order. The computing platform may generate training data based on the maintenance request and the enriched work order, and may use the training data to train a plurality of regression models. The plurality of regression models to identify a plurality of technicians to handle the maintenance request and the computing platform may transmit the enriched work order to the plurality of technicians. The computing platform may continuously train the plurality of regression models based on feedback from the plurality of technicians.

### CROSS-REFERENCE TO RELATED APPLICATIONS

This application is a continuation of U.S. patent application Ser. No. 18/105,424, filed Feb. 3, 2023 (as attorney docket 009475.00005), and is also a continuation of PCT/US2023/61926, filed Feb. 3, 2023 (as attorney docket 009475.00004), both of which claim the benefit of priority to both U.S. Provisional Patent Application 63/357,682, filed Jul. 1, 2022 (as attorney docket 009475.00003), and U.S. Provisional Patent Application 63/306,794, filed Feb. 4, 2022 (as attorney docket 009475.00002). All of the aforementioned are herein incorporated by reference in their entireties.

### BACKGROUND

Home and property maintenance are reactive, time-consuming, and costly for landlords, property management companies, and/or homeowners. Related pain is felt by residents, homeowners, and technicians due to the time that it takes to resolve an issue based on a lack of information and/or transparency. For example, a typical maintenance problem may be identified by a resident of a rental unit. The resident may log into a portal to report the problem and/or catalog the issue(s), for example, via an online form. After reporting the problem, the resident may wait several days before a technician (e.g., maintenance worker) is sent out. The resident may have to take off from work to be there when the technician arrives and answer any questions the technician may have. Based on the technician's visit and the information obtained during the initial visit, the problem may not be resolved and may require another visit, requiring additional time off from work for the resident, as well as another visit by the technician. Accordingly, residents may feel as though their time and energy is wasted reporting issues and waiting for them to be fixed, which may drive frustrations that cause a resident to look for a new place to live. Technicians share in the residents' frustrations due to the lack of information shared before the initial visit and the multiple visits needed to resolve an issue. Finally, landlords and/or property management companies are frustrated by the operating expenditures associated with property maintenance, the lack of visibility to proactively resolve issues before they arise, and the turnover rate with which residents come and go based, in part, on poor maintenance experiences. Thus, typical maintenance resolution systems result in an inefficient use of time and/or resources and stakeholder frustration.

### SUMMARY

Aspects of the disclosure address one or more of the drawbacks mentioned above by disclosing methods, computer readable media, and apparatuses associated with an artificial intelligence (“AI”) platform that intakes and generates work orders with a higher degree of accuracy, completes advanced diagnostics before a technician/vendor is sent out, advises tenants and/or homeowners on do-it-yourself (DIY) solutions, and/or builds intelligent home profiles. The AI platform described herein delivers a better maintenance experience for all stakeholders (e.g., landlords, property management companies, homeowners, and/or tenants).

Aspects of the disclosure may be provided in a computer-readable medium having computer-executable instructions to perform one or more of the process steps described herein.

This summary is provided to introduce a selection of concepts in a simplified form that are further described below in the detailed description. The summary is not intended to identify key features or essential features of the claimed subject matter, nor is it intended to be used to limit the scope of the claimed subject matter. Moreover, one or more of the steps and/or components described above may be optional or may be combined with other steps.

### BRIEF DESCRIPTION OF THE DRAWINGS

Systems and methods are illustrated by way of example and are not limited in the accompanying figures in which like reference numerals indicate similar elements and in which:

FIG. 1 shows an illustrative operating environment in which various aspects of the disclosure may be implemented.

FIG. 2A shows an example of an interaction between a chatbot and a user in accordance with certain aspects of the disclosure.

FIG. 2B shows a flowchart of triaging a problem with a toilet in accordance with one or more aspects of the disclosure. FIG. 2A and FIG. 2B may be collectively referred to as “FIG. 2.”

FIG. 3 shows an example of an interaction between a chatbot and a user in accordance with certain aspects of the disclosure.

FIG. 4 shows an example of an interaction between a chatbot and a user in accordance with certain aspects of the disclosure.

FIG. 5A shows an example of a system configured to execute the artificial intelligence-driven chatbot in accordance with certain aspects of the disclosure.

FIG. 5B shows an example of an illustrative diagnosis engine configured to execute in accordance with certain aspects of the disclosure.

FIG. 5C, FIG. 5D, and FIG. 5E show examples of flowcharts for obtaining information from a user in accordance with one or more aspects of the disclosure. FIGS. 5A-5D may be collectively referred to as “FIG. 5.”

FIG. 6 shows an example of an illustrative routing and assignment engine configured to execute in accordance with certain aspects of the disclosure.

FIG. 7 shows example regression models for troubleshooting and diagnosing maintenance issues in accordance with certain aspects of the disclosure.

FIG. 8 shows an illustrative artificial neural network on which a machine learning algorithm may be executed in accordance with one or more examples described herein.

FIG. 9 shows an example of a system configured to generate a work order using the artificial intelligence-driven chatbot and to assign a technician to the maintenance repair job indicated on the work order.

FIG. 10 shows an example flowchart for generating a list of potential technicians/vendors to perform the maintenance repair job indicated on the work order.

### DETAILED DESCRIPTION

In light of the foregoing background, the following presents a simplified summary of the present disclosure in order to provide a basic understanding of some aspects of the concepts disclosed herein. This description is not an extensive overview of the invention. This description is not intended to identify key features or essential features of the claimed subject matter, nor is it intended to be used to limit the scope of the claimed subject matter. This description is provided to introduce a selection of concepts in a simplified form that are further described below. It is to be understood that other embodiments may be utilized and structural and functional modifications may be made.

In accordance with various aspects of the disclosure, methods, computer-readable media, and apparatuses are disclosed involving an artificial intelligence (AI)-driven chatbot configured to diagnose and troubleshoot problems using conversational prompts. The AI-driven chatbot may complete advanced diagnostics, generate work orders with a higher degree of accuracy, advise tenants and/or homeowners on do-it-yourself (DIY) solutions, and/or build intelligent home profiles using the conversational prompts.

In the following description of the various embodiments of the disclosure, reference is made to the accompanying drawings, which form a part hereof, and in which is shown by way of illustration, various embodiments in which the disclosure may be practiced. It is to be understood that other embodiments may be utilized and structural and functional modifications may be made.

Machine learning (“ML”) has enabled the automated processing of problems formerly limited to human intervention. Traditionally, computers have been explicitly programmed to perform tasks, meaning that even fairly simple tasks can take significant amounts of programming time to implement. Machine learning may be used to allow a computer to perform the same or similar tasks without being explicitly programmed to do so. For example, where formerly a programmer may have manually programmed a face detection algorithm (e.g., providing code telling a computer to look for two eyes, a nose, and a mouth), machine learning may be used instead by providing a computer with a large set of pictures of human faces (e.g., some winking, some smiling, some partially obscured) and rewarding the computer for correct identifications of human faces over repeated trials. Colloquially, such methods may be said to allow a machine learning algorithm to both think and learn.

Machine learning has benefits far beyond programming efficiency: machines may also learn and identify correlations in data that would otherwise go undetected if reviewed by humans. For example, a video game company may know that players are likely to play video games during weekends, but may be unable to determine a formerly unknown correlation between weather (e.g., the cold and/or amount of snow) and the number of players on a game at any given time. While a human would be unlikely to detect such a correlation given the volume of data involved and a lack of a motivation to compare such datasets, a machine learning algorithm may do so largely without human intervention.

Machine learning algorithms are asked to label data in large data sets. For example, a machine learning algorithm may be asked to label a face in a photograph, or to indicate the presence or absence of a face in an entire photo. Other forms of machine learning algorithm output have been implemented. For example, a machine learning algorithm may be asked to make future predictions based on current data, may be asked to group data, may be asked to determine human-language responses to queries, or the like.

Machine learning is of increasing interest in fields where significant human time and subjective decision-making is otherwise necessary. Many voice-controlled artificial intelligence systems rely on machine learning to better understand spoken words and phrases. While human-programmed voice recognition systems have existed previously, machine learning algorithms allow for the rapid adaptation of voice-controlled AI systems to handle, for example, poorly spoken words and colloquialisms. Machine learning can even be used for areas of subjective taste. For example, some video streaming companies use machine learning to improve their video recommendation engine. While programming a video recommendation engine by hand is possible (e.g., one that recommends action movies if a user watches many action movies), machine learning algorithms have proven particularly adept at identifying and acting on user preferences that are not easily predicted.

A framework for machine learning algorithm may involve a combination of one or more components, sometimes three components: (1) representation, (2) evaluation, and (3) optimization components. Representation components refer to computing units that perform steps to represent knowledge in different ways, including but not limited to as one or more decision trees, sets of rules, instances, graphical models, neural networks, support vector machines, model ensembles, and/or others. Evaluation components refer to computing units that perform steps to represent the way hypotheses (e.g., candidate programs) are evaluated, including but not limited to as accuracy, prediction and recall, squared error, likelihood, posterior probability, cost, margin, entropy k-L divergence, and/or others. Optimization components refer to computing units that perform steps that generate candidate programs in different ways, including but not limited to combinatorial optimization, convex optimization, constrained optimization, and/or others. In some embodiments, other components and/or sub-components of the aforementioned components may be present in the system to further enhance and supplement the aforementioned machine learning functionality.

Machine learning algorithms sometimes rely on unique computing system structures. Machine learning algorithms may leverage neural networks, which are systems that approximate biological neural networks (e.g., the human brain). Such structures, while significantly more complex than conventional computer systems, are beneficial in implementing machine learning. For example, an artificial neural network may be comprised of a large set of nodes which, like neurons in the brain, may be dynamically configured to effectuate learning and decision-making.

Machine learning tasks are sometimes broadly categorized as either unsupervised learning or supervised learning. In unsupervised learning, a machine learning algorithm is left to generate any output (e.g., to label as desired) without feedback. The machine learning algorithm may teach itself (e.g., observe past output), but otherwise operates without (or mostly without) feedback from, for example, a human administrator. An embodiment involving unsupervised machine learning is described herein.

Meanwhile, in supervised learning, a machine learning algorithm is provided feedback on its output. Feedback may be provided in a variety of ways, including via active learning, semi-supervised learning, and/or reinforcement learning. In active learning, a machine learning algorithm is allowed to query answers from an administrator. For example, the machine learning algorithm may make a guess in a face detection algorithm, ask an administrator to identify the photo in the picture, and compare the guess and the administrator's response. In semi-supervised learning, a machine learning algorithm is provided a set of example labels along with unlabeled data. For example, the machine learning algorithm may be provided a data set of 100 photos with labeled human faces and 10,000 random, unlabeled photos. In reinforcement learning, a machine learning algorithm is rewarded for correct labels, allowing it to iteratively observe conditions until rewards are consistently earned. For example, for every face correctly identified, the machine learning algorithm may be given a point and/or a score (e.g., “75% correct”). An embodiment involving supervised machine learning is described herein.

One theory underlying supervised learning is inductive learning. In inductive learning, a data representation is provided as input samples data (x) and output samples of the function (f(x)). The goal of inductive learning is to learn a good approximation for the function for new data (x), i.e., to estimate the output for new input samples in the future. Inductive learning may be used on functions of various types: (1) classification functions where the function being learned is discrete; (2) regression functions where the function being learned is continuous; and (3) probability estimations where the output of the function is a probability.

As elaborated herein, in practice, machine learning systems and their underlying components are tuned by data scientists to perform numerous steps to perfect machine learning systems. The process is sometimes iterative and may entail looping through a series of steps: (1) understanding the domain, prior knowledge, and goals; (2) data integration, selection, cleaning, and pre-processing; (3) learning models; (4) interpreting results; and/or (5) consolidating and deploying discovered knowledge. This may further include conferring with domain experts to refine the goals and make the goals more clear, given the nearly infinite number of variables that can possible be optimized in the machine learning system. Meanwhile, one or more of data integration, selection, cleaning, and/or pre-processing steps can sometimes be the most time consuming because the old adage, “garbage in, garbage out,” also reigns true in machine learning systems.

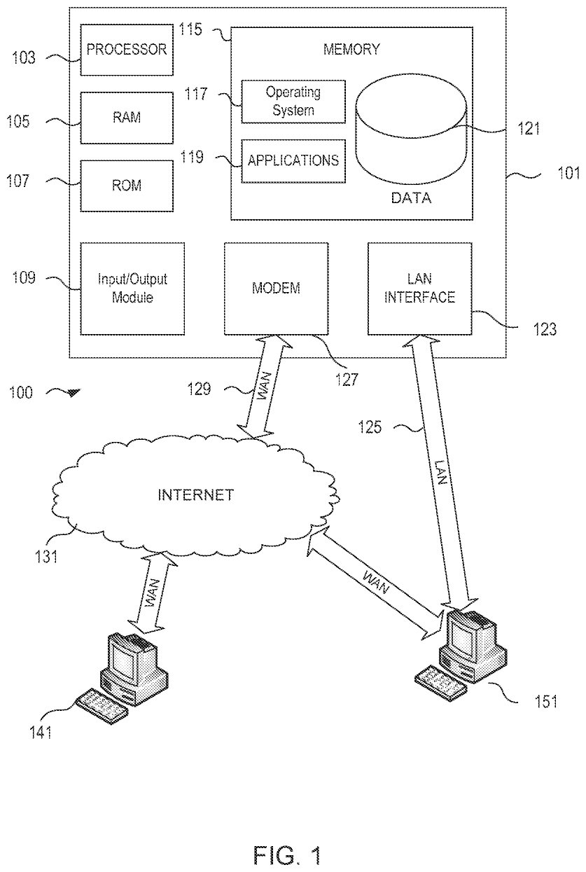

FIG. 1 illustrates a block diagram of an AI-driven chatbot in a communication system 100 that may be used according to an illustrative embodiment of the disclosure. The computer server 101 may have a processor 103 for controlling overall operation of the server 101 and its associated components, including RAM 105, ROM 107, input/output (I/O) module 109, and memory 115.

I/O 109 may include a microphone, keypad, touch screen, and/or stylus through which a user of device 101 may provide input, and may also include one or more of a speaker for providing audio output and a video display device for providing textual, audiovisual and/or graphical output. Software may be stored within memory 115 to provide instructions to processor 103 for enabling server 101 to perform various functions. For example, memory 115 may store software used by the server 101, such as an operating system 117, application programs 119, and an associated database 121. Processor 103 and its associated components may allow the server 101 to run a series of computer-readable instructions to deploy program instructions according to the type of request that the server receives. For instance, if a client requests that program instructions for capturing mouse movements for complete session replay be executed, server 101 may transmit the appropriate instructions to a user's computer when that user visits the client's website.

The server 101 may operate in a networked environment supporting connections to one or more remote computers, such as terminals 141 and 151. The terminals 141 and 151 may be personal computers or servers that include many or all of the elements described above relative to the server 101. Alternatively, terminal 141 and/or 151 may be part of a cloud computing environment located with or remote from server 101 and accessed by server 101. The network connections depicted in FIG. 1 include a local area network (LAN) 125 and a wide area network (WAN) 129, but may also include other networks. When used in a LAN networking environment, the server 101 is connected to the LAN 125 through a network interface or adapter 123. When used in a WAN networking environment, the server 101 may include a modem 127 or other means for establishing communications over the WAN 129, such as the Internet 131. It will be appreciated that the network connections shown are illustrative and other means of establishing a communications link between the computers may be used. The existence of any of various well-known protocols such as TCP/IP, Ethernet, File Transfer Protocol (FTP), Hypertext Transfer Protocol (HTTP) and the like is presumed.

Additionally, an application program 119 used by the server 101 according to an illustrative embodiment of the disclosure may include computer executable instructions for invoking functionality related to delivering program instructions and/or content.

Computing device 101 and/or terminals 141 or 151 may also be mobile terminals including various other components, such as a battery, speaker, and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, and distributed computing environments that include any of the above systems or devices, and the like.

The disclosure may be described in the general context of computer-executable instructions, such as program modules, being executed by a computer. Generally, program modules include routines, programs, objects, components, data structures, etc. that perform particular tasks or implement particular abstract data types. The disclosure may also be practiced in distributed computing environments where tasks are performed by remote processing devices that are linked through a communications network. In a distributed computing environment, program modules may be located in both local and remote computer storage media including memory storage devices.

Referring to FIG. 1, an illustrative system for implementing methods according to the present disclosure is shown. As illustrated, system may include one or more workstations 141, 151. Workstations 141, 151 may be local or remote, and are connected by one or more communications links to computer network 101. In certain embodiments, workstations 141, 151 may be different storage/computing devices for storing and delivering client-specific program instructions or in other embodiments workstations may be user terminals that are used to access a client website and/or execute a client-specific application. Computer network 100 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links may be any communications links suitable for communicating between workstations and server, such as network links, dial-up links, wireless links, hard-wired links, etc.

The steps that follow in the Figures may be implemented by one or more of the components in FIG. 1 and/or other components, including other computing devices.

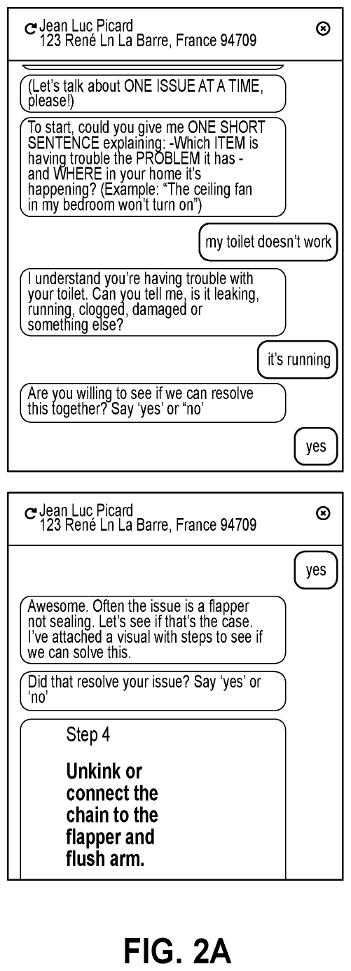

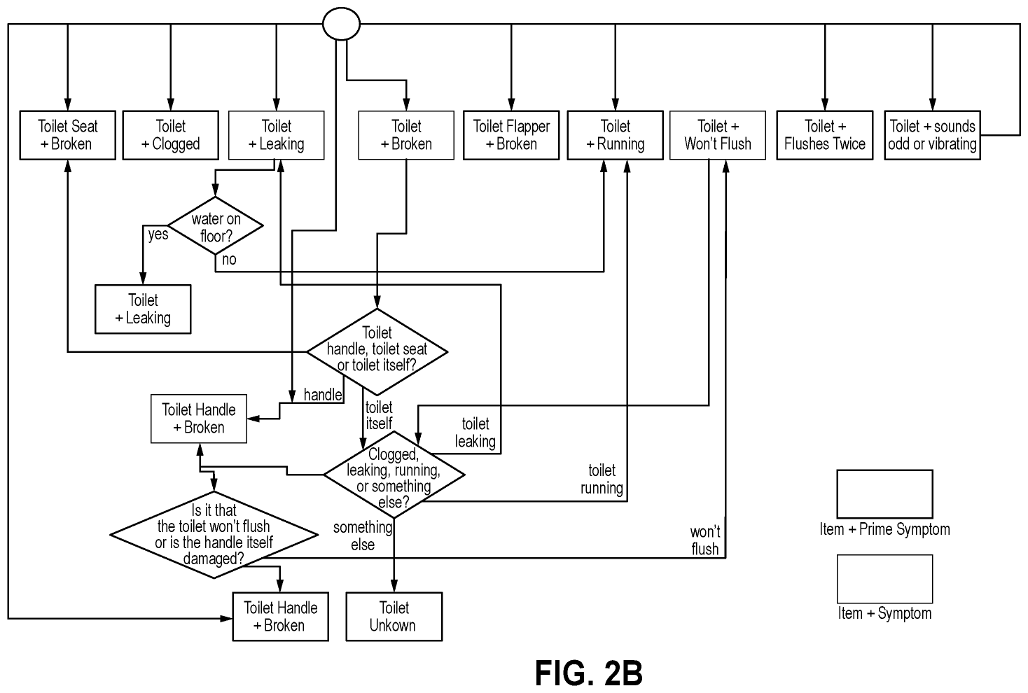

The present disclosure describes an AI-driven, natural language processing (NLP), omnichannel chatbot to address stakeholder frustrations with existing maintenance reporting systems. FIG. 2A shows an example of the chatbot interaction with a user device associated with a user (e.g., a cellular phone, a desktop computer, a laptop, a mobile device, a tablet, or the like), according to one or more aspects of the disclosure. In particular, FIG. 2A shows an interaction between the chatbot and the user device via text message. Although text messaging is shown in FIG. 2A, it will be appreciated that any form of messaging may be used, including, for example, instant messaging, a chat session, a short message service (SMS), a multimedia message service (MMS), and the like.

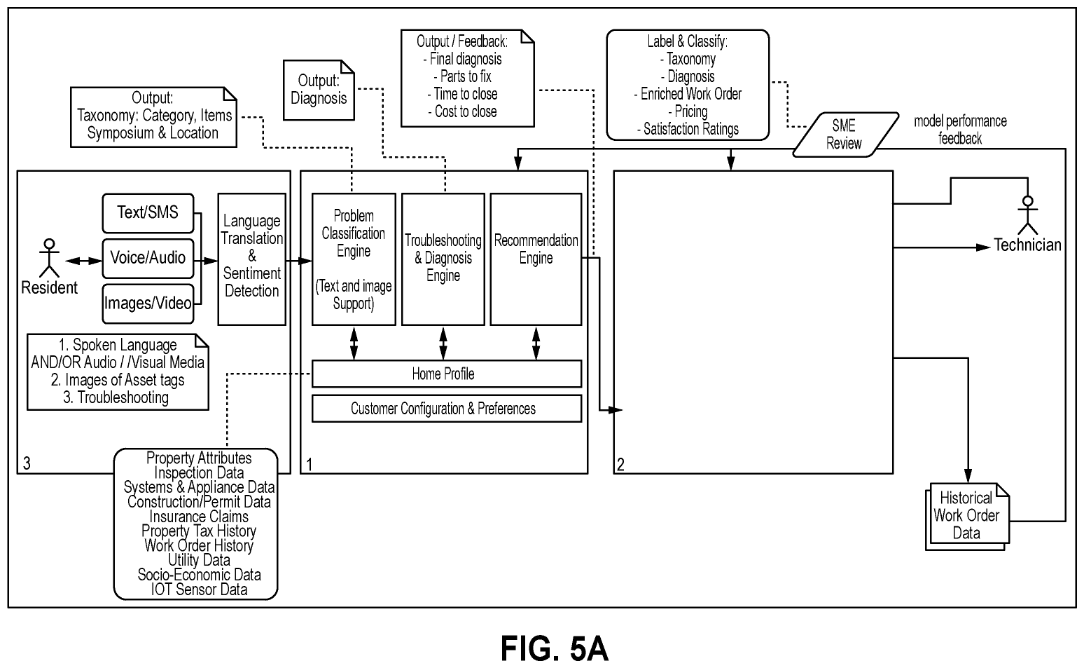

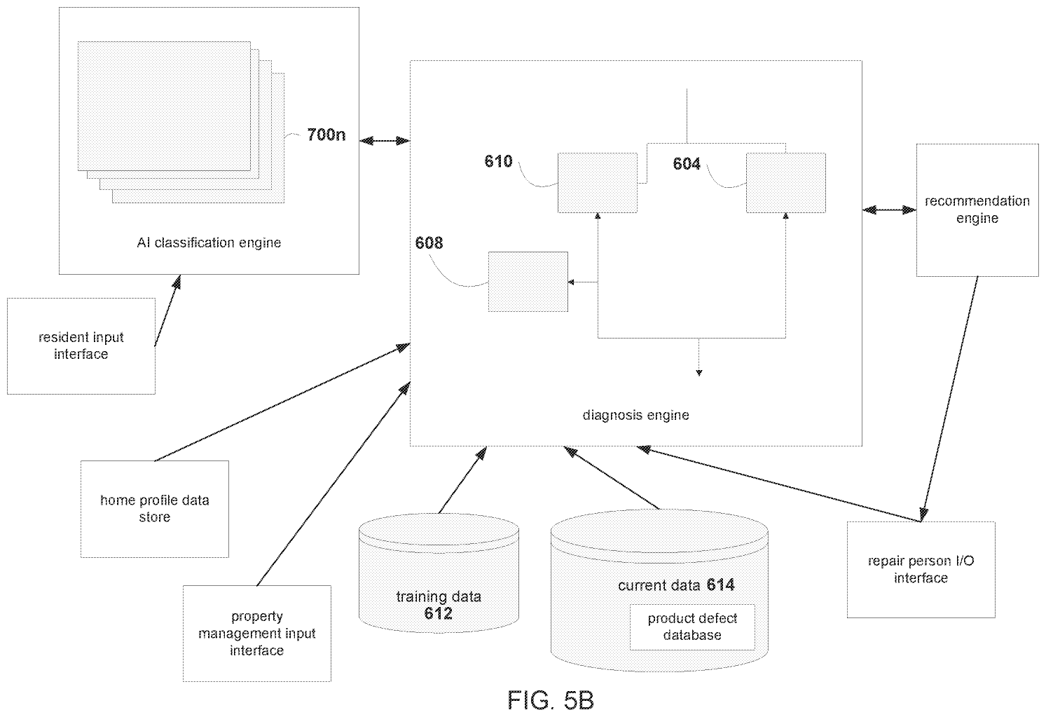

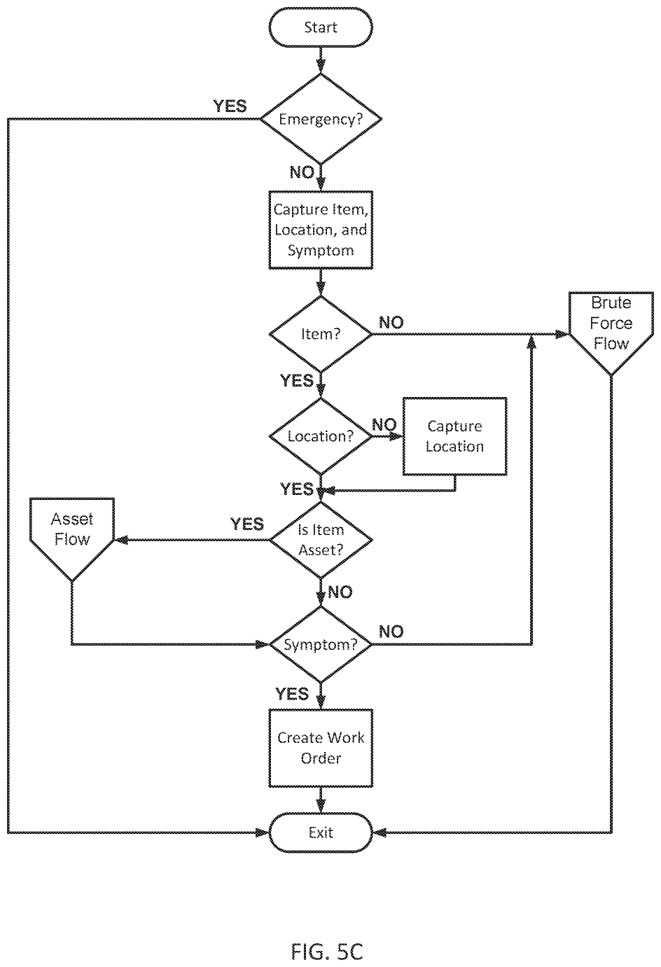

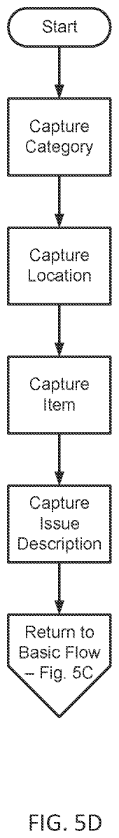

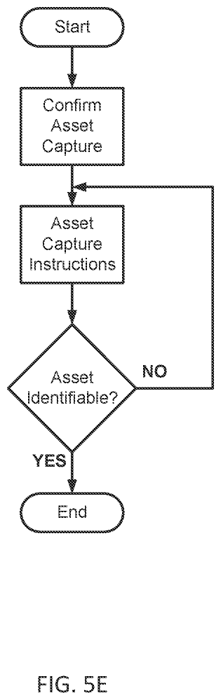

As shown in FIG. 2A, the chatbot's first communication may comprise one or more messages that set forth guidelines for the user to describe an issue the user is having. The first communication may be based on, or in response to, a user initially communicating with the chat bot. Alternatively, the first communication may occur in a chat session window of a webpage that the user has navigated to via a browser. In response to the first communication, the user may respond with a description of the problem he/she is having. In some embodiments, the user response may comprise a maintenance repair request (e.g., a request for assistance with a malfunctioning item, a request for suggestions on how to fix the malfunctioning item without the help of a technician, or the like (e.g., vendor)). As shown in FIG. 2A, the user has responded with “my toilet doesn't work.” As will be discussed in greater detail below with respect to FIG. 5A, the chatbot may make a determination whether the user's communication contains a threshold level of information to begin diagnosing the problem. The determination may be based on whether the user has identified an item, a symptom, a location, and/or a component. An item may be a physical item located in a rental unit, such as a sink, a toilet, a dishwasher, a refrigerator, a washing machine, a dryer, a ceiling, a wall, and the like. A symptom may include a problem with the item (e.g., a running toilet, a leaking toilet, a clogged toilet, a damaged toilet, a broke toilet flapper, a leaking ceiling, etc.). In other examples, a symptom may include a running toilet; a leaking toilet; a clogged toilet; a damaged toilet; a broken toilet flapper; sounds noisy; smells; leaking; broken; detached; dirty; clogged; mold; mildew; need management; burning; upkeep; damaged; missing; loose; not turning on or off; not cooling; not working; not opening or closing; infestation; bad water pressure; no air; not heating; electrical overload; running; not flushing; or the like. A location may specify a room, a building, an address, etc. A component may be a part (e.g., piece) of an item. For example, a component may be a flapper of a toilet, a toilet seat, a toilet lid, a toilet tank, a dishwasher rack, a lint trap for a dryer, etc. Other examples of components may include a toilet seat; a toilet lid; a toilet tank; a toilet flapper; base; bolts; bowl; fill valve; flapper; flush kit; handle; line; pull chain; seat; shut-off valve; and/or tank. In some examples, information may be inferred from the information provided. In this regard, a bathroom location may be inferred by the chatbot (e.g., the machine learning underlying the chatbot) if a user indicates a problem with a toilet, a shower, a bathtub, etc. Similarly, the chatbot may be able to infer an item based on a component identified in the conversation. For example, a resident may identify a problem as “a flapper not seating correctly” Like the example above, the chatbot (e.g., the machine learning supporting the chatbot) may infer that the problem is with a toilet based on the user identifying the flapper. Based on the information received from the user and the information that the chatbot is able to infer, the chatbot may determine and select an appropriate response.

For example, if the chatbot determines that there is not enough information to begin diagnosing the problem, the chatbot may determine what information is missing or cannot be inferred and select an appropriate response to the user. As shown in FIG. 2A, the chatbot recognizes that the user has not identify a symptom (e.g., problem) with the toilet. The chatbot may select a response designed to elicit additional information from the user. Accordingly, the chatbot may respond to the user with: “I understand you're having trouble with your toilet. Can you tell me, is it leaking, running, clogged, damaged, or something else?” The user may then provide additional information that will allow the chatbot to identify the problem and/or offer solutions to the problem. As illustrated in FIG. 2A, the user identifies that the toilet is “running.” Again, the chatbot may determine whether the chatbot (e.g., the machine learning algorithms) has sufficient information to begin diagnosing (e.g., troubleshooting) the problem.

When the chatbot determines that there is sufficient information to begin diagnosing the problem, the chatbot may inquiry whether the user wants to try and resolve the issue. If the user indicates “no,” the chatbot may offer to schedule a technician visit for the user. In this regard, the chatbot may be able to perform a work order intake using the information provided by the user during the conversation. Additionally or alternatively, the chatbot may generate an enriched work order, which may be provided to the technician (e.g. via transmission to a technician device associated with the technician, wherein the technician device comprises at least one of a mobile device, a cellular phone, a laptop computer, a tablet, or the like). This may allow the technician to obtain the correct parts (e.g., corresponding SKUs), tools, and/or personnel to resolve the problem quicker and/or reduce the number of visits to the unit.

If the user indicates that he or she does want to try to resolve the issue, the chatbot may provide one or more instructions (e.g., steps) for the user to perform in an attempt to resolve the issue. FIG. 2A shows the chatbot identifying the problem (i.e., “Often the issue is a flapper not sealing.”) and offering one or more solutions to resolve the problem. The one or more solutions may be instructions or links to videos to help the user resolve the problem. After each solution offered, the chatbot may inquire to determine whether the solution resolved the problem. If so, then the interaction between the chatbot and the user may conclude. However, if the solution did not solve the problem, the chatbot may offer another solution. Accordingly, the process may be repeated until the problem is resolved or the number of solutions are exhausted. If the possible solutions are exhausted without the problem being resolved, the chatbot may then offer to schedule a technician visit to address the problem. As discussed above, the chatbot may perform a work order intake using the information provided by the user during the conversation. Additionally or alternatively, the chatbot may generate an enriched work order, which may be provided to the technician to help the technician identify the problem, possible parts (e.g., corresponding SKUs) needed, potential tools, and the appropriate personnel for resolving the issue.

FIG. 2B shows an example of a flowchart that a chatbot may undertake in triaging a problem with a toilet. FIG. 2B shows a plurality of items and symptoms. The shaded-in boxes may identify prime symptoms (e.g., damaged toilet, toilet seat broken, toilet clogged, toilet handle broken, toilet leaking water on the floor, toilet flapper broken, toilet running, toilet flushes twice, toilet sounds odd or vibrates) that do not require further information. Accordingly, the chatbot may move on to troubleshooting and/or diagnosing the problems associated with prime symptoms. The unshaded boxes represent symptoms (or general symptoms) that may require additional information. As shown in FIG. 2B, toilet leaking may prompt the chatbot to ask the user whether toilet is leaking water on the floor. If so, the chatbot may conclude that the toilet is leaking. However, if the toilet is not leaking water on the floor, the chatbot may conclude that the toilet is running. The chatbot may proceed with troubleshooting and/or diagnosing those issues, respectively. In another example, a toilet broken prompt may cause the chatbot to response with a request for additional information to identify what component of the toilet is broken. As shown in FIG. 2B, the component may be the handle, the toilet seat, or the toilet itself. The chatbot may continue to make requests of the user until the chatbot can reasonably diagnose the problem with the toilet. While a flowchart for diagnosing a toilet is shown in FIG. 2B, it will be appreciated that similar flowcharts may exist for other fittings, fixtures, home appliances, and/or home machinery.

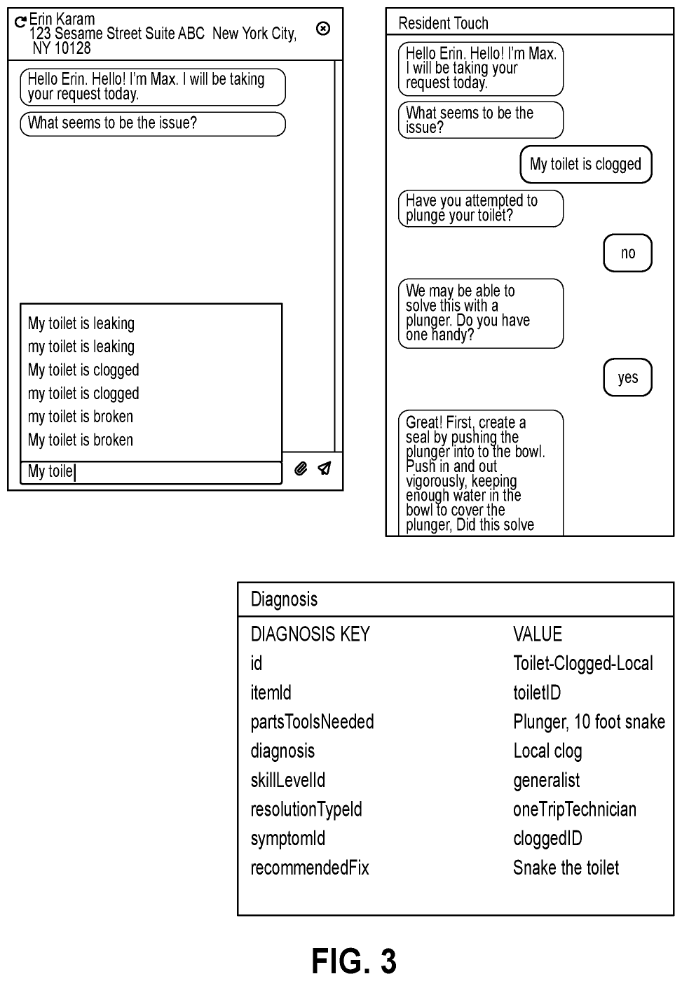

FIG. 3 shows another example of a chatbot interaction with a user according to one or more aspects of the disclosure. Like FIG. 2A, FIG. 3 shows an interaction between the chatbot and the user via text message, however, any suitable messaging protocol may be used, including instant messaging, a chat session, SMS, MMS, and the like.

In FIG. 3, the chatbot's first communication may comprise an introduction and the second communication may be an inquiry to help identify the problem a user is having. In response to the second communication, a user may begin typing a description of the problem. As illustrated in FIG. 3, an autocomplete option may be offered. The autocomplete option may identify common problems. Additionally or alternatively, the autocomplete option may phrase in a manner more suitable for the chatbot to consume the user's response. As shown FIG. 3, the user may respond with “My toilet is clogged.” Based on this response, the chatbot may recognize that the chatbot needs to know whether the user has the appropriate equipment to try and remediate the clogged toilet. Accordingly, the chatbot may inquire whether the user has a plunger. In response to receiving an indication that the user does indeed have a plunger, the chatbot may then provide instructions on how to unclog a toilet using a plunger. After providing the instructions on how to unclog a toilet, the chatbot may inquire to determine whether the solution remediated the problem. If so, then the interaction between the chatbot and the user may conclude. However, if the solution did not solve the problem, the chatbot may offer another solution. For example, the chatbot may ask (e.g., inquire) whether the user has tools to fix the toilet (e.g., a plumber's snake; a wrench; a plunger; a pair of pliers; a screwdriver; a toilet auger; adjustable wrench; channel lock pliers; flat head screwdriver; Phillips head screwdriver; new toilet; new toilet tank lid; new toilet tank; wax ring; rubber seal; Teflon tape; plumber's tape; supply line; putty knife; bucket; toilet bolts; needle nose pliers; flapper; hand auger; 100-foot commercial auger; toilet auger; plunger; pipe cutter; shutoff valve; vacuum; fill valve; power drill; flange; flush kit; toilet handle; tank to bowl kit; tank lid; utility knife; hammer; chisel; sandpaper; caulk gun; caulk; flooring; toilet seat; and/or the like). Like above, the interaction between the user and the chatbot may be repeated until the problem is remediated or the number of solutions are exhausted. If the possible solutions are exhausted without the problem being resolved, the chatbot may schedule an appointment with a technician to resolve the problem. As noted previously, the chatbot may perform a work order intake using the information provided by the user during the conversation. Additionally or alternatively, the chatbot may generate an enriched work order, which may be provided to the technician to help the technician identify the problem, possible parts needed, potential tools, and the appropriate personnel for resolving the issue.

FIG. 3 illustrates an example work order based on the information collected by the chatbot. As shown in the FIG. 3, the information includes an identification of the problem (e.g., “Toilet-Clogged-Local”), the item at issue (e.g., “toiletID”), the parts and/or tools needed by the technician (e.g., “plunger, 10 foot snake”), a diagnosis made by the chatbat (e.g., “Local clog”), a skill level of the technician (e.g., “generalist”), a resolution type (e.g., “oneTripTechnician”), an identification of the symptom (e.g., “cloggedID”), and/or a recommended solution (e.g., “Snake the toilet”). This information may be sent to the technician, for example, in a work order to help remediate the problem more quickly and efficiently.

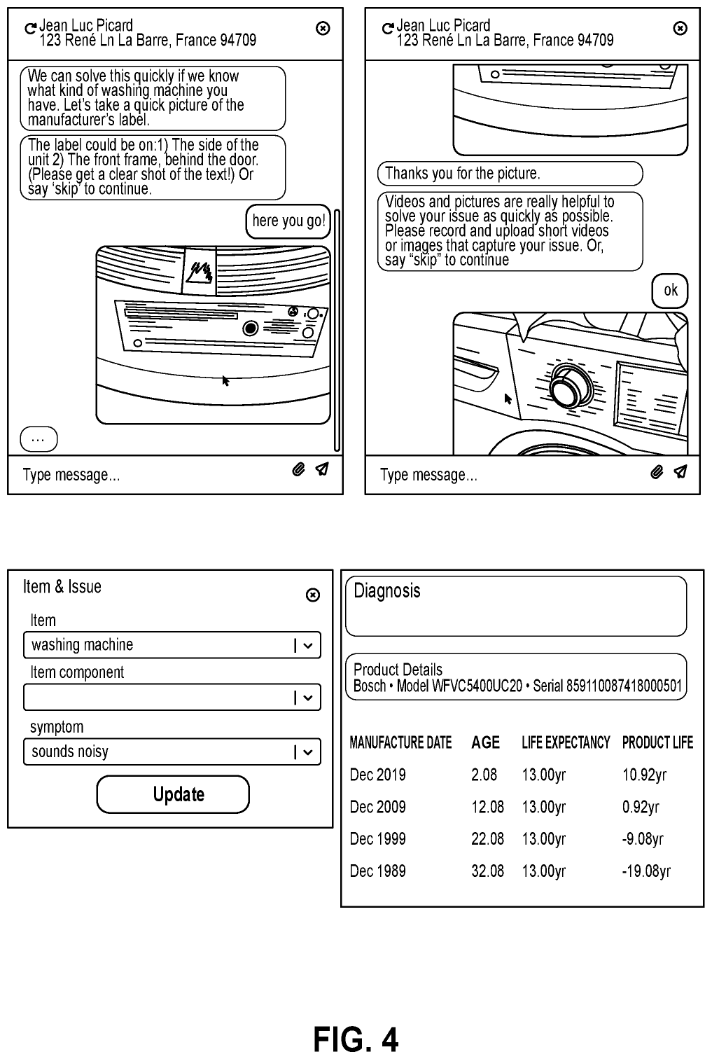

FIG. 4 shows yet another example of a chatbot interaction with a user according to one or more aspects of the disclosure. Like the figures above, FIG. 4 shows an interaction between the chatbot and the user via text message, however, any suitable messaging protocol may be used, including instant messaging, a chat session, SMS, MMS, and the like. The interaction shown in FIG. 4 may be substantially similar to the interactions described in FIGS. 2 and 3. However, the interaction shown in FIG. 4 differs from previously described interactions in that the interaction shows a user uploading (e.g., sending) images of an item to the chatbot. As shown in FIG. 4, the user provides images of a washing machine; however, it will be appreciated that images of any household item may be sent to the chatbot. Upon receiving the images, the chatbot (e.g., the machine learning algorithms supporting the chatbot) may perform image analysis to identify information and/or details about the item. The information and/or details make include a make and model of the device and/or a serial number of the device. In some examples, the information and/or details may include an image or video illustrating the problem the user is having. The chatbot (e.g., the machine learning algorithms supporting the chatbot) may use image analysis to obtain relevant information (e.g., make and model of the device, serial number of the device, etc.) from the image and/or video. The information obtained from the images and/or videos may help the chatbot (e.g., the machine learning algorithms behind the chatbot) to identify suitable replacement parts and/or tools for remediating the problem with the device.

The interactions described above show an AI-driven, omnichannel chatbot that addresses stakeholder frustrations with existing maintenance reporting systems. In particular, the chatbot may intake work orders with a high degree of accuracy by classifying and structuring data based on a particular taxonomy. Moreover, in some examples, the system identifies a diagnosis, and then leverages one or more models to make a recommendation for the solve—all gathering information: the taxonomy, signs, diagnosis, and/or recommendation may be submitted as a work order that corresponds to the maintenance request (e.g., toilet maintenance request). The system may also gather additional signs and/or information about the issue pertaining to context about the incident, observational information on components or parts involved as well as context of other related issues that might be observed in the home. Further, the conversational AI may allow the chatbot to triage and diagnose symptoms to identify the root cause and complete an advanced diagnostic of the problem. Additionally, the chatbot may coach (e.g., instruct) users on do-it-yourself (DIY) solutions. This may resolve problems quicker and provide cost-savings in reducing the number of trips (e.g., visits) required by technicians. Moreover, the chatbot may generate an enriched work order that more accurately describes the problem and possible solutions, thereby providing technicians with the appropriate parts, tools, and personnel required to remediate the problem. This approach reduces the numbers of trips (e.g., visits) a technician has to make prior to resolving the issue. Finally, the chatbot interactions may build an intelligent profile for each unit (e.g., apartment, home, etc.). The intelligent profile may allow for real-time asset lookup and capture, which can be used to identify appropriate parts, tools, and personnel required to remediate the problem. Additionally, the intelligent profile may be used to identify items that require service, maintenance, and/or replacement based on known and/or predicted lifecycles and prior to issues arising.

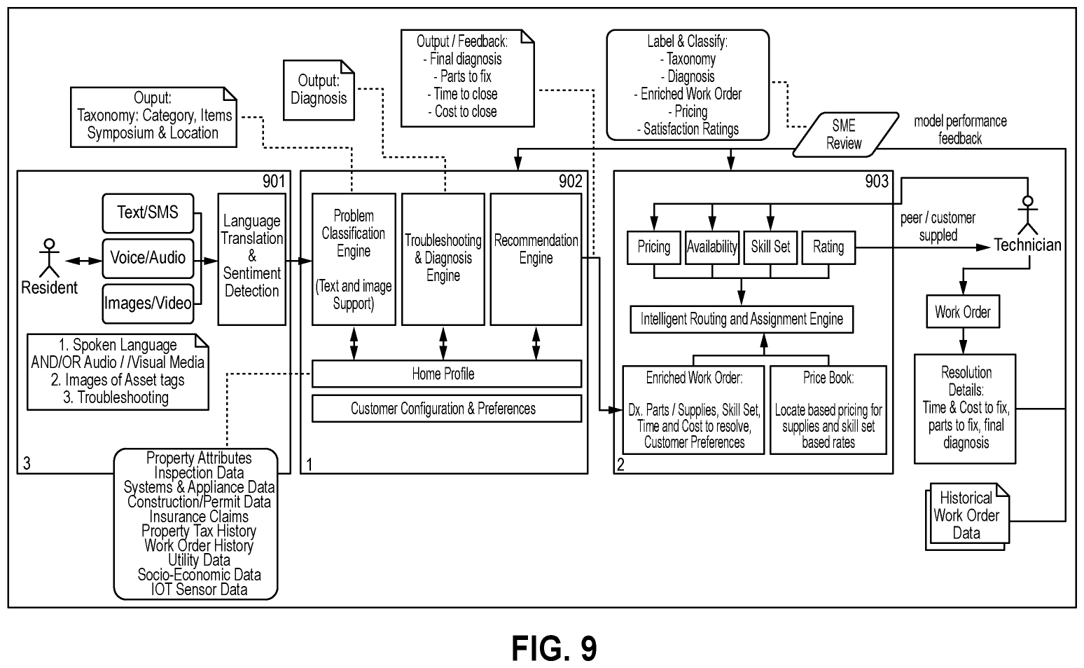

As discussed above with respect to FIGS. 2-4, the AI-driven chatbot may be used to alleviate stakeholders' frustrations by instructing tenants and/or homeowners on DIY solutions, completing advanced diagnostics before a technician is assigned, generating work orders with a higher degree of accuracy, and/or building intelligent profiles for each unit. FIG. 5A illustrates an example of a system implementing the AI-driven chatbot. As shown in FIG. 5A, the system may comprise an input component (e.g., input component 901, as discussed in connection with FIG. 9), a processing component (e.g., processing component 902, as discussed in connection with FIG. 9), and resolution/fulfillment component (e.g., resolution/fulfillment component 903, as discussed in connection with FIG. 9).

The input component may comprise an interface configured to interact with users. The interface may be the chatbot interacting with users as described above with respect to FIGS. 2-4. Accordingly, the interface may be a text messaging interface, an instant messaging interface, a chat session, an SMS interface, an MMS interface, or the like. Additionally or alternatively, the interface may comprise an audio interface (e.g., a phone line), a video interface (e.g., a conferencing solution (i.e., Zoom®)), or any combination of a messaging interface, an audio interface, a video interface. In some instances, the interface may use a speech-to-text algorithm to convert (e.g., transform) speech into text for analysis purposes.

After receiving the input via the interface, communications may be sent (e.g., transmitted) to the processing component. As shown in FIG. 5A, the processing component may comprise a Problem Classification Engine, a Language Translation & Sentiment Detection Engine, a Troubleshooting & Diagnosis Engine, and/or a Recommendation Engine. The processing component may also store profile information, as well as customer configuration and preferences.

The Problem Classification Engine may be may be configured to perform natural language processing (NLP) to identify key words and/or phrases. The Language Translation & Sentiment Detection Engine may work in tandem with the Problem Classification Engine to normalize text, analyze the text, and/or perform sentiment analysis on inputs received from a resident.

The Language Translation & Sentiment Detection Engine may be configured to process the received inputs to normalize the text. In this regard, the Language Translation & Sentiment Detection Engine may identify words and/or phrases in the input. That is, the Language Translation & Sentiment Detection Engine may extract features (e.g., words and/or phrases) that may be input into one or more machine learning models. The words and/or phrases may be identified using a regular expression (regex) tool (e.g., one-hot encoding), a count vectorizer, a text analysis tool (e.g., term-frequency-inverse document frequency), or any combination thereof to identify the words or phrases. Additionally or alternatively, the Language Translation & Sentiment Detection Engine may detect the user's sentiment based on the received input. That is, the Language Translation & Sentiment Detection Engine may analyze the text to determine whether the input is positive, negative, or neutral. The Language Translation & Sentiment Detection Engine may extract one or more features from the text and input the features to one or more machine learning modes, such as Naive-Bayes, linear regression, support vector machines, or any other suitable machine learning model. The one or more machine learning models may provide (e.g., output) an indication of the whether the received input is positive, negative, or neutral.

The words and/or phrases may be analyzed by the Problem Classification Engine, using one or more NLP algorithms, to identify one or more key words and/or phrases. The one or more NLP algorithms may be supervised machine learning models configured to perform text classification, like k-nearest neighbor (KNN), naive-bayes, XGBoost, catboost, lightGBM, or any other suitable gradient boosting machine learning model. Additionally or alternatively, the one or more NLP algorithms may be an unsupervised machine learning model, such as Lb12Vec or k-means clustering. The one or more NLP algorithms may analyze the text to identify one or more keywords and/or phrases. The one or more NLP algorithms may determine whether the inputs match existing classifications and/or identifiers. In some examples, a first model may be used to identify an item and/or a system. The first model may use named-entity recognition (NER) to identify the item and/or the symptom. A second model (e.g., a second, separate algorithm for NER) may be used to identify a location and/or a component. Both models may be trained using a series of keywords, synonyms, and/or phrases associated with the particular entity/node (e.g., the item, the symptom, the location, or the component). The identified entities/nodes may be fed into the one or more machine learning models to select a conversational pathway. Additionally or alternatively, the Problem Classification Engine may use an edge case model to identify problems, such as leaks, mold, mildew, and/or other uncommon cases. The edge case model may use a combination of encodings (tf-idf, word2vec) and algorithms (e.g., K-nearest neighbors (KNN), Naive Bayes (NB), etc.) to identify the edge cases and add the result to the first and/or second model. Based on the first and second models, a third model may be generated. The third model may be a specific classification model that expands classification to symptoms that are specific to an item (e.g., toilet-running, door-stuck, etc.). The third model may build on similar tools used to generate the edge case model. The third model may add more complicated algorithms, like Tensorflow-Keras neural networks and bidirectional encoder representation and transformers (BERT) encodings. In some instances, the classification set may be limited to item-specific options for symptom, component, and/or location (e.g., no hose component for door). This may be a rule-based symptom that dynamically pulls an item-specific model using a tool depending on a quantity of data. For example, Tensorflow may be used for large data sets (e.g., >1000), while naive-bayes/KNN may be used for smaller data sets.

As discussed above with respect to FIGS. 2-4, the one or more NLP algorithms may be configured to identify an item, a symptom, a location, and/or a component. In some instances, the one or more NLP algorithms may determine whether a threshold amount of information was received. Additionally or alternatively, the one or more NLP algorithms may determine whether a prime symptom has been identified. Based on whether the inputs match existing classifications and/or identifiers, whether a threshold amount of information has been received, and/or whether a prime symptom has been identified, the one or more NLP algorithms may identify a conversational pathway to enter to troubleshoot and/or diagnose the problem. The conversational pathway may be sent (e.g., transmitted) to the Troubleshooting & Diagnosis Engine. Alternatively, the Problem Classification Engine may send the keywords and/or phrases to the Troubleshooting & Diagnosis Engine, which may then select the conversational pathway.

The Troubleshooting & Diagnosis Engine may be configured to troubleshoot and/or diagnose the problem. As noted above, the Troubleshooting & Diagnosis Engine may receive an indication of a conversational pathway from the Problem Classification Engine. Alternatively, the Troubleshooting & Diagnosis Engine may receive one or more inputs from the Problem Classification Engine (e.g., data and/or information outputted by the Problem Classification Engine) and determine (e.g., select) a conversational pathway based on the one or more inputs received from the Problem Classification Engine. As noted above, the Troubleshooting & Diagnosis Engine may identify the problem statement from the user's original input. In particular, Troubleshooting & Diagnosis Engine may identify the item, the symptom, the location, and/or the component. Additionally or alternatively, the Troubleshooting & Diagnosis Engine may determine whether the original input comprises enough information to begin troubleshooting and diagnosing the problem. In another alternative, the Troubleshooting & Diagnosis Engine may determine whether the original input comprises a general symptom (e.g., being broken) or a prime symptom (e.g., broken in a specific way). Based on the analysis of the input (e.g., whether it identifies an item, a symptom, a location, and/or a component; whether it contains enough information; whether it identifies a prime symptom, etc.), the Troubleshooting & Diagnosis Engine may select a conversational pathway.

Returning to the example discussed above in FIG. 2A, the Troubleshooting & Diagnosis Engine may determine that the original input (e.g., “my toilet doesn't work”) may identify an item, a location, and a general symptom. Accordingly, the Troubleshooting & Diagnosis Engine may determine that the original input does not include enough information to begin troubleshooting or diagnosing the problem. Based on the determination, the Troubleshooting & Diagnosis Engine may select a conversational response designed to confirm the original input and elicit more information. As shown in the example illustrated in FIG. 2A, the conversational response selected by the Troubleshooting & Diagnosis Engine is: “I understand you're having trouble with your toilet. Can you tell me, is it leaking, running, clogged, damaged or something else?” The user may then respond with “it's running,” which may be analyzed by both the Problem Classification Engine and the Troubleshooting & Diagnosis Engine. Based on the information contained in the response and/or the original input, the Troubleshooting & Diagnosis Engine may identify a prime symptom. Additionally or alternatively, the Troubleshooting & Diagnosis Engine may determine that there is enough information (e.g., a threshold amount) to begin troubleshooting and/or diagnosing the problem. Accordingly, the Troubleshooting & Diagnosis Engine may select a conversational response. The conversational response may be further down the pathway of the originally selected conversational pathway. Additionally or alternatively, the conversational response may be a new conversational pathway configured to diagnose the problem. The diagnosis conversational response can be seen in the chatbot responses in FIG. 2A (e.g., “Are you willing to see if we can resolve this together? Say ‘yes’ or ‘no’”; “Awesome. Often the issue is a flapper not sealing. Let's see if that's the case. I've attached a visual with steps to see if we can solve this.”). The Troubleshooting & Diagnosis Engine may also generate (e.g., create) the diagnosis information seen, for example, in FIG. 3. If the user is able to remediate (e.g., solve) the problem based on the instructions provided by the Troubleshooting & Diagnosis Engine, then the analysis may conclude. Additionally or alternatively, the diagnosis and the outcome may be stored in the Home Profile information, for example, for future reference. However, if the problem is unable to be resolved, the diagnosis information may be sent (e.g., transmitted) to the Recommendation Engine.

The Recommendation Engine may be configured to determine the next steps for resolving (e.g., remediating) the problem. The Recommendation Engine may analyze the diagnosis information. Based on the diagnosis information, the Recommendation Engine may generate a work order. The work order may identify at least one of the item, the component, the location, the prime symptom, tools/parts required for the repair, a skill level for the repair, and/or a number of trips for the repair. Additionally or alternatively, the Recommendation Engine may send the work order to the resolution/fulfillment component to have a technician complete the repair.

As noted above, the system described herein may store Home Profile information. The Home Profile information may comprise information about the unit (e.g., a user home, or the like), such as the number of bedrooms, bathrooms, etc. Additionally or alternatively, the Home Profile information may comprise information about the equipment and/or machinery located in a unit. Furthermore, the Home Profile Information may describe a layout of the unit in which the item is located, a location of the item within the unit, a geographic location of the unit, an identification and/or classification of a type of unit, a number of working bedrooms, bathrooms, and/or kitchens, the type of appliances/assets in the home, whether the home has shared common areas, a garage, and/or outdoor space, or the like. The Home Profile information may be used by the Problem Classification Engine and/or the Troubleshooting & Diagnosis Engine in each of their respective analyses. For example, the Problem Classification Engine may receive input that a resident is having issue with his or her garage door opener. The Problem Classification Engine may analyze the Home Profile information associated with the unit to determine whether the unit has a garage. If not, the Problem Classification Engine may select an appropriate response. In another example, the Troubleshooting & Diagnosis Engine may receive an indication that a resident does not have hot water. The Troubleshooting & Diagnosis Engine may use the data and/or information stored in the Home Profile information to determine the age of the hot water heater associated with the resident's unit. The age of the hot water heater may factor into the diagnosis of why the resident does not have hot water.

The resolution/fulfillment component may be configured to receive information from the Recommendation Engine and/or determine how to resolve a problem. The resolution/fulfillment component may generate an (or another) enriched work order based on the information provided by the Recommendation Engine. As noted above, the enriched work order may indicate the diagnosis, parts and supplies needed to complete the job, an expected time needed to complete the job, an expected cost of the job, and/or customer preferences (e.g., best times to fix problem, contact info, etc.). The output of the Recommendation Engine (e.g., an enriched work order or other output) may be sent to a fulfillment engine (shown as the box labeled “2” in FIG. 5A). The resolution/fulfillment component may send information from the enriched work order to a technician. The resolution/fulfillment component may comprise multiple modules (e.g., one or more of a pricing module, an availability module, a skill set module, or a rating module). The pricing module may determine an estimated cost of a job based on local pricing for supplies, a billing rate based on the skill set required for the job, and/or the number of hours required for the job. The technician availability module may be configured to determine a technician's schedule. The technician skill set module may maintain a table (or database) of available the skill set associated with each available technician (e.g., a generalist, a fixture specialist, a water heater specialist, etc.). The technician rating module may store ratings and/or reviews associated with each available technician based on previous jobs completed by each technician. The pricing module, the availability module, the skill set module, and the rating module may be used by the routing and assignment engine to assign a technician to a worker order.

Referring to FIG. 5B, in an embodiment involving supervised machine learning, a data store (e.g., graph database) may store the relationships between collected training data and current data and other inputs. A supervised machine learning model may provide an indication to a graph module interfacing with the graph database that output from the ML model was correct and/or incorrect. In response to that indication, the graph module may update the graph database to improve the accuracy of predictions. The modifications may be based on historical data, a feedback loop, or from an external source, such as property management's preferences or rules sets, another computing device, or the like. Where feedback is received and causes the diagnosis engine to adjust its predictions, the machine learning model may be referred to as a supervised machine learning model. Although the aforementioned example refers to a graph database, the disclosure is not so limited. Other forms and types of data stores may be used with the diagnosis engine to assist in predicting and troubleshooting maintenance requests from the user's/resident input interface. For example, pathways 700n (e.g., programmatic rule sets) in the AI classification engine may be combined with data extracted from the resident user interface to suggest diagnosis name-value pairings for consideration in the diagnosis engine.

In supervised learning, a machine learning algorithm is provided feedback on its output. Feedback may be provided in a variety of ways, including via active learning, semi-supervised learning, and/or reinforcement learning. In active learning, a machine learning algorithm is allowed to query answers from an administrator. For example, the machine learning algorithms (e.g., 604, 608, 610) of the diagnosis engine may make a prediction solely or in coordination with other algorithms/models. Similar to the NLP algorithms described herein, one or more models (604, 608, and/or 610) may analyze the inputs to predict whether the inputs match existing diagnoses and/or identifiers. In some examples, a first model may be used to identify an item, component, and/or a system; and a second model may be used to identify a location, general symptom, and/or prime symptom. More or less models (e.g., three models, four models, or more models) may be used in coordination. Then, the diagnosis engine may use the actual input from the repair person input/output (I/O) interface to compare the generated prediction to that of the administrator/supervisor. The diagnosis engine may adjust the confidence value of its predictions and adjust weights accordingly. In some examples, other users (e.g., a DIY resident) may provide the supervisory response into the diagnosis engine. In yet other examples, the input may be automatically pulled from the system (e.g., through sensors or other means).

Meanwhile, in reinforcement learning, the machine learning algorithm is rewarded for correct predictions of diagnosis name-value pairs, allowing it to iteratively observe conditions until rewards are consistently earned. For example, for every repair correctly identified, the machine learning algorithm may be given a point and/or a score (e.g., “85% correct”).

In some examples, the diagnosis engine may identify relationships between nodes (e.g., in a graph database) that previously may have gone unrecognized. For example, using a collaborative filtering technique, the diagnosis engine may identify that a node representing a repair should be connected to the user's location, which is an attribute of the user/resident. The diagnosis engine may have identified that other repairs involving users that identified the same location have also diagnosis engine learning engine may increase the weight of the repair node and subsequently adjust the weight of adjacent/connected nodes. This may result in particular nodes adjusting their confidence values/scores to push those nodes to an updated outcome from a Boolean false to a Boolean true. Other examples of machine learning techniques may be used in combination or in lieu of a collaborative filtering technique.

Regarding unsupervised anomaly detection, a diagnosis engine (e.g., an unsupervised diagnosis engine) may construct feature vectors using the data store (e.g., graph database). For example, each node (e.g., an itemID, symptomID, componentID, locationID, and other IDs) and its associated edges may be converted into a feature vector. An unsupervised feature vector may include data about each component, item, location, etc. stored in a historical data store, current data store, training data store, and/or other data store. An unsupervised feature vector may also include a score. The score may represent the confidence score of the node. The feature vector may also include current data. For example, the feature vector may include data related to ongoing repair data of the corresponding node. The unsupervised diagnosis engine may use the unsupervised feature vectors in a machine learning algorithm to detect anomalies within the graph. The unsupervised diagnosis engine may use any machine learning model to detect anomalies within the graph including support vector machines, isolation forest model, K-nearest neighbors (KNN), Naive Bayes (NB), and/or other techniques. For example, the unsupervised diagnosis engine may use a clustering technique to cluster the unsupervised feature vectors to determine whether any of the nodes (e.g., items, components, locations, etc.) are exhibiting unusual behavior/symptoms. The unsupervised diagnosis engine may use any clustering algorithm (e.g., K-means, affinity propagation, mean-shift, spectral clustering, Ward hierarchical clustering, agglomerative clustering, density-based spatial clustering of applications with noise (DBSCAN), Gaussian mixtures, Birch, shared nearest neighbors, etc.). The clustering algorithm may use a distance metric such as Euclidean distance, Manhattan distance, cosine distance, etc. to determine distances between unsupervised feature vectors when clustering. unsupervised diagnosis engine may determine that some clusters are anomalous because of their differences from other clusters.

In one example, the unsupervised diagnosis engine may use an autoencoder technique to detect anomalies within the graph. The autoencoder may be constructed with a number of layers that represent the encoding portion of the network and a number of layers that represent the decoding portion of the network. The encoding portion of the network may output a vector representation of inputs into the encoder network, and the decoding portion of the network may receive as input a vector representation generated by the encoding portion of the network. It may then use the vector representation to recreate the input that the encoder network used to generate the vector representation. The autoencoder may be trained on historical data or feature vectors that are known to not be anomalous. By training on non-anomalous feature vectors, the autoencoder may learn how a non-anomalous node behaves. When the autoencoder encounters a feature vector that is different from the feature vectors it has trained on, the unsupervised diagnosis engine may flag the feature vector as potentially anomalous. In some examples, the autoencoder may be a variational autoencoder. The variational autoencoder may include the components of the autoencoder. The variational autoencoder may also include a constraint on its encoding network that forces it to generate vector representations of inputs according to a distribution (e.g., a unit Gaussian distribution). In other examples, the unsupervised diagnosis engine may use other techniques like Tensorflow-Keras neural networks and bidirectional encoder representation and transformers (BERT) encodings.

A graph representation of nodes and relationships may be analyzed by an unsupervised machine learning model. As discussed in greater detail above, an unsupervised machine learning model may be used to determine, among other things, correlations in data sets without external feedback (e.g., a score associated with machine learning output). Such an unsupervised machine learning model may be executed on a graph representation of nodes and relationships in order to determine, for example, how a characterization of one node (e.g., a determination of a flaw or error in one node) may adjust the confidence value associated with connected nodes.

An unsupervised machine learning model may analyze a graph representation using definitional functions. Definitional functions may comprise, for example, a definition of the relationship between two nodes and/or the definition of a node. A definitional function may be, for example, descriptive (e.g., describing a characteristic of a component/item/etc.), quantitative (e.g., describing numerically the degree of similarity of two components/items), and/or qualitative. An unsupervised machine learning model may use definitional functions defining a node to determine how weights associated with a node may originate and adjust the weight of related nodes. A definitional function may influence how an unsupervised machine learning model interprets a quantity and/or characterization involving a node. For example, a definitional function may indicate that a particular brand of toilets with a known defect/recall, which is published in an accessible data store (e.g., a current data store), are more likely to have the particular defect (e.g., a loose tank seal). As such, the unsupervised machine learning model may use this definitional rule, in conjunction with input data, to calculate that risk is marginally more likely (or significantly more or less likely) in some circumstances.

An unsupervised machine learning model need not obey a definitional function or treat a definitional function as fact. In additional to or alternatively to the definitional functions each node in a given graph representation of one or more repairs may be associated with one or more machine learning models, such that the graph representation may be associated with a limitless number of machine learning models. Each machine learning model may be supervised and/or unsupervised and be configured in any of the manners described above. Each node and/or class of nodes may be associated with one or more machine learning models which may make decisions with regard to the graph and/or with regard to risk. For example, one node may have a supervised machine learning model using a first set of definitional functions, whereas another node may have an unsupervised machine learning model using a second set of definitional functions. As another example, a class of nodes (e.g., door bell camera) may be associated with a first type of machine learning model, whereas a second class of nodes (e.g., smart home thermostat) may be associated with a set of machine learning models configured to operate in series and/or in parallel.

Multiple machine learning models may be used together to make decisions. The output of one machine learning model may be used as the input of another machine learning model, and/or multiple machine learning models may execute in parallel, such that decision-making may comprise the use of a limitless number of machine learning models. While the disclosure contemplates numerous different approaches to implementing the disclosed system, in one example, the system may be implemented through server-side components, client-side components, and objects. For example, see FIG. 5B, which illustrates just one example of a sample network configuration of the components/modules/systems interacting. Other configurations and interactions are contemplated and the illustration of FIG. 5A is not meant to be limiting.

Turning to FIG. 5C, a basic flowchart of a chatbot obtaining information using the Problem Classification Engine and the Troubleshooting & Diagnosis Engine is shown. The process may begin with the chatbot inquiring whether the problem a resident is having is an emergency. If so, the process ends with instructions that the resident contact a property manager at a phone number. If not, the process proceeds to capture item, location, and symptom information. As noted above, the chatbot, or artificial intelligence (e.g., an automated voice response system), may receive an input via one or more interfaces (e.g., chat, voice, video, etc.). The chatbot, using the Problem Classification Engine and/or the Troubleshooting & Diagnosis Engine, may determine whether the input comprises an item.

If not, the chatbot proceeds to the Brute Force flow shown in FIG. 5D, discussed in greater detail below. If the input comprises the item, the chatbot determines whether the input comprises location information. Location information may be provided by the resident and may comprise a room, a building, an address, etc. However, if the location information is not provided by the resident, then the location information may be captured by the chatbot. For example, the location information may be determined by the user logging-in to report a problem. The log-in information and the location information may be correlated with the Home Profile information described above. Once location information is obtained, the chatbot may determine whether the item is an asset. If the item is an asset, the chatbot proceeds to the Asset flow shown in FIG. 5E and discussed in greater detail below. After the asset analysis, the chatbot may determine whether the resident has identified a symptom. If not, the chatbot may proceed to the Brute Force flow shown in FIG. 5D to determine the symptom. Once the symptom is provided, the chatbot may create a work order and the process may terminate. When creating the work order, in some examples, the system identifies a diagnosis, and then leverages one or more models to make a recommendation for the solve—all gathering information: the taxonomy, signs, diagnosis, and/or recommendation may be submitted as a work order that corresponds to the maintenance request (e.g., toilet maintenance request). The system may also gather additional signs and/or information about the issue pertaining to context about the incident, observational information on components or parts involved as well as context of other related issues that might be observed in the home.

As noted above FIG. 5D shows a Brute Force process for the chatbot to obtain the information to identify a problem, diagnose the problem, and/or generate a work order to resolve the problem. The Brute Force process may begin with the chatbot capturing a category for the problem. In this regard, the chatbot may ask a resident to describe his or her problem. Additionally or alternatively, the chatbot may provide a list of options (e.g., a pick list) for the resident to select a category of problem he or she is having. After identifying the category, the chatbot may capture the location of the problem. As noted above, the location may be a room, a building, an address, etc. The location may be obtained from the resident by inquiry. Additionally or alternatively, the location information may be obtained by accessing an account associated with the resident. The account may comprise information indicating the resident's address, building, unit number, etc. After the location information is captured, the chatbot may proceed to identify the item that is malfunctioning or not working properly. Again, the chatbot may ask the resident to type the item that is not working. Alternatively, the chatbot may present the resident with a list of items. The resident may select one or more items from the list of items that the resident would like to have serviced or maintained. Before returning to the Basic Flow described in FIG. 5C, the chatbot may capture a description of the issue. As discussed above, the chatbot may allow the resident to enter a description of his or her issue in a free form field. Alternatively, the chatbot may provide the resident with a list of issues to select from. Once the user has provided the requisite information, the Brute Force flow returns to the Basic Flow shown in FIG. 5C.

FIG. 5E shows a flowchart for capturing data (e.g., asset information). The process begins with the chatbot confirming capture of an asset. Once confirmed, the chatbot may provide instructions for capturing images or videos of the asset. Once the images or videos of the asset are captured, the chatbot may determine whether the asset is identifiable. In some examples, a convolutional neural network may assist in attempting to identify the asset. If the asset is not identifiable, the chatbot may again provide instructions for capturing images or video of the asset. If the asset is recognizable, the flow ends and returns to the Basic Flow shown in FIG. 5C.

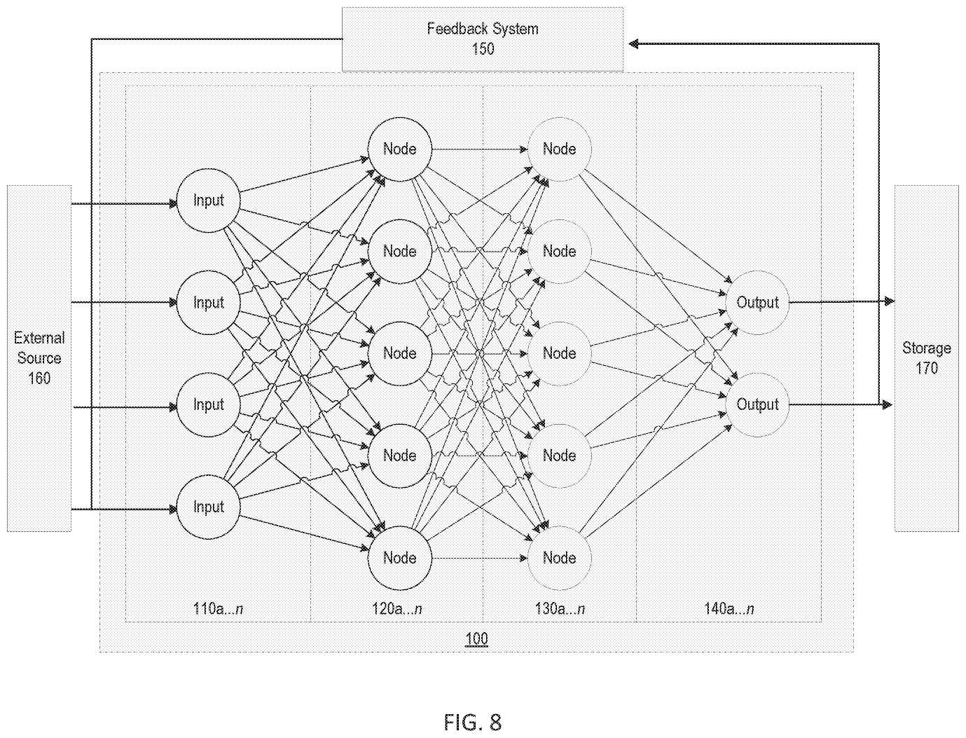

By way of example, FIG. 8 illustrates a simplified example of an artificial neural network 100 on which a machine learning algorithm may be executed. FIG. 8 is merely an example of nonlinear processing using an artificial neural network; other forms of nonlinear processing may be used to implement a machine learning algorithm in accordance with features described herein.

In FIG. 8, each of input nodes 110a-n is connected to a first set of processing nodes 120a-n. Each of the first set of processing nodes 120a-n is connected to each of a second set of processing nodes 130a-n. Each of the second set of processing nodes 130a-n is connected to each of output nodes 140a-n. Though only two sets of processing nodes are shown, any number of processing nodes may be implemented. Similarly, though only four input nodes, five processing nodes, and two output nodes per set are shown in FIG. 8, any number of nodes may be implemented per set. Data flows in FIG. 8 are depicted from left to right: data may be input into an input node, may flow through one or more processing nodes, and may be output by an output node. Input into the input nodes 110a-n may originate from an external source 160. Output may be sent to a feedback system 150 and/or to storage 170. The feedback system 150 may send output to the input nodes 110a-n for successive processing iterations with the same or different input data.

In one illustrative method using feedback system 150, the system may use machine learning to determine an output. The output may include anomaly scores, weight scores/values, confidence values, and/or classification output. The system may use any machine learning model including xgboosted decision trees, auto-encoders, perceptron, decision trees, support vector machines, regression, and/or a neural network. The neural network may be any type of neural network including a feed forward network, radial basis network, recurrent neural network, long/short term memory, gated recurrent unit, auto encoder, variational autoencoder, convolutional network, residual network, Kohonen network, and/or other type. In one example, the output data in the machine learning system may be represented as multi-dimensional arrays, an extension of two-dimensional tables (such as matrices) to data with higher dimensionality.

The neural network may include an input layer, a number of intermediate layers, and an output layer. Each layer may have its own weights. The input layer may be configured to receive as input one or more feature vectors described herein. The intermediate layers may be convolutional layers, pooling layers, dense (fully connected) layers, and/or other types. The input layer may pass inputs to the intermediate layers. In one example, each intermediate layer may process the output from the previous layer and then pass output to the next intermediate layer. The output layer may be configured to output a classification or a real value. In one example, the layers in the neural network may use an activation function such as a sigmoid function, a Tanh function, a ReLu function, and/or other functions. Moreover, the neural network may include a loss function. A loss function may, in some examples, measure a number of missed positives; alternatively, it may also measure a number of false positives. The loss function may be used to determine error when comparing an output value and a target value. For example, when training the neural network the output of the output layer may be used as a prediction and may be compared with a target value of a training instance to determine an error. The error may be used to update weights in each layer of the neural network.

In one example, the neural network may include a technique for updating the weights in one or more of the layers based on the error. The neural network may use gradient descent to update weights. Alternatively, the neural network may use an optimizer to update weights in each layer. For example, the optimizer may use various techniques, or combination of techniques, to update weights in each layer. When appropriate, the neural network may include a mechanism to prevent overfitting— regularization (such as L1 or L2), dropout, and/or other techniques. The neural network may also increase the amount of training data used to prevent overfitting.

Once data for machine learning has been created, an optimization process may be used to transform the machine learning model. The optimization process may include (1) training the data to predict an outcome, (2) defining a loss function that serves as an accurate measure to evaluate the machine learning model's performance, (3) minimizing the loss function, such as through a gradient descent algorithm or other algorithms, and/or (4) optimizing a sampling method, such as using a stochastic gradient descent (SGD) method where instead of feeding an entire dataset to the machine learning algorithm for the computation of each step, a subset of data is sampled sequentially. In one example, optimization comprises minimizing the number of false positives to maximize a user's experience. Alternatively, an optimization function may minimize the number of missed positives to optimize minimization of losses from exploits.

In one example, FIG. 8 depicts nodes that may perform various types of processing, such as discrete computations, computer programs, and/or mathematical functions implemented by a computing device. For example, the input nodes 110a-n may comprise logical inputs of different data sources, such as one or more data servers. The processing nodes 120a-n may comprise parallel processes executing on multiple servers in a data center. And, the output nodes 140a-n may be the logical outputs that ultimately are stored in results data stores, such as the same or different data servers as for the input nodes 110a-n. Notably, the nodes need not be distinct. For example, two nodes in any two sets may perform the exact same processing. The same node may be repeated for the same or different sets.

Each of the nodes may be connected to one or more other nodes. The connections may connect the output of a node to the input of another node. A connection may be correlated with a weighting value. For example, one connection may be weighted as more important or significant than another, thereby influencing the degree of further processing as input traverses across the artificial neural network. Such connections may be modified such that the artificial neural network 100 may learn and/or be dynamically reconfigured. Though nodes are depicted as having connections only to successive nodes in FIG. 8, connections may be formed between any nodes. For example, one processing node may be configured to send output to a previous processing node.

Input received in the input nodes 110a-n may be processed through processing nodes, such as the first set of processing nodes 120a-n and the second set of processing nodes 130a-n. The processing may result in output in output nodes 140a-n. As depicted by the connections from the first set of processing nodes 120a-n and the second set of processing nodes 130a-n, processing may comprise multiple steps or sequences. For example, the first set of processing nodes 120a-n may be a rough data filter, whereas the second set of processing nodes 130a-n may be a more detailed data filter.

The artificial neural network 100 may be configured to effectuate decision-making. As a simplified example for the purposes of explanation, the artificial neural network 100 may be configured to detect faces in photographs. The input nodes 110a-n may be provided with a digital copy of a photograph. The first set of processing nodes 120a-n may be each configured to perform specific steps to remove non-facial content, such as large contiguous sections of the color red. The second set of processing nodes 130a-n may be each configured to look for rough approximations of faces, such as facial shapes and skin tones. Multiple subsequent sets may further refine this processing, each looking for further more specific tasks, with each node performing some form of processing which need not necessarily operate in the furtherance of that task. The artificial neural network 100 may then predict the location on the face. The prediction may be correct or incorrect.

The feedback system 150 may be configured to determine whether or not the artificial neural network 100 made a correct decision. Feedback may comprise an indication of a correct answer and/or an indication of an incorrect answer and/or a degree of correctness (e.g., a percentage). For example, in the facial recognition example provided herein, the feedback system 150 may be configured to determine if the face was correctly identified and, if so, what percentage of the face was correctly identified. The feedback system 150 may already know a correct answer, such that the feedback system may train the artificial neural network 100 by indicating whether it made a correct decision. The feedback system 150 may comprise human input, such as an administrator telling the artificial neural network 100 whether it made a correct decision. The feedback system may provide feedback (e.g., an indication of whether the previous output was correct or incorrect) to the artificial neural network 100 via input nodes 110a-n or may transmit such information to one or more nodes. The feedback system 150 may additionally or alternatively be coupled to the storage 170 such that output is stored. The feedback system may not have correct answers at all, but instead base feedback on further processing: for example, the feedback system may comprise a system programmed to identify faces, such that the feedback allows the artificial neural network 100 to compare its results to that of a manually programmed system.

The artificial neural network 100 may be dynamically modified to learn and provide better input. Based on, for example, previous input and output and feedback from the feedback system 150, the artificial neural network 100 may modify itself. For example, processing in nodes may change and/or connections may be weighted differently. Following on the example provided previously, the facial prediction may have been incorrect because the photos provided to the algorithm were tinted in a manner which made all faces look red. As such, the node which excluded sections of photos containing large contiguous sections of the color red could be considered unreliable, and the connections to that node may be weighted significantly less. Additionally or alternatively, the node may be reconfigured to process photos differently. The modifications may be predictions and/or guesses by the artificial neural network 100, such that the artificial neural network 100 may vary its nodes and connections to test hypotheses.

The artificial neural network 100 need not have a set number of processing nodes or number of sets of processing nodes, but may increase or decrease its complexity. For example, the artificial neural network 100 may determine that one or more processing nodes are unnecessary or should be repurposed, and either discard or reconfigure the processing nodes on that basis. As another example, the artificial neural network 100 may determine that further processing of all or part of the input is required and add additional processing nodes and/or sets of processing nodes on that basis.

The feedback provided by the feedback system 150 may be mere reinforcement (e.g., providing an indication that output is correct or incorrect, awarding the machine learning algorithm a number of points, or the like) or may be specific (e.g., providing the correct output). For example, the machine learning algorithm 100 may be asked to detect faces in photographs. Based on an output, the feedback system 150 may indicate a score (e.g., 75% accuracy, an indication that the guess was accurate, or the like) or a specific response (e.g., specifically identifying where the face was located).

The artificial neural network 100 may be supported or replaced by other forms of machine learning. For example, one or more of the nodes of artificial neural network 100 may implement a decision tree, associational rule set, logic programming, regression model, cluster analysis mechanisms, Bayesian network, propositional formulae, generative models, and/or other algorithms or forms of decision-making. The artificial neural network 100 may effectuate deep learning.

As illustrated in FIG. 5A by way of introduction, once user input is received via the input component 901 and a work order (or enriched work order) is generated by the processing component 902 of the computing system employing the artificial intelligence-driven chatbot, the work order (or enriched work order) is transmitted to the fulfillment component 903 of the computing system. FIG. 9 illustrates the engines and components that the fulfillment component uses to identify a technician (or plurality of technicians) who is capable of performing the maintenance repair job and to assign the maintenance repair job to the technician. As illustrated in FIG. 9, the fulfillment component is comprised of the intelligent routing and assignment engine. The intelligent routing and assignment engine may receive a plurality of inputs, including a price associated with a technician, the technician's availability, the technician's skill set(s), and a rating associated with the technician, all of which are discussed in further detail below.

The intelligent routing and assignment engine may receive, as input, the work order (or the enriched work order) that is generated by the chatbot, as discussed in connection with FIG. 3, and may receive, as input, the price book. The work order (or enriched work order) may contain information collected by the chatbot and from the user. The information collected by the chatbot may include an identification of the problem (e.g., “Toilet-Clogged-Local”), the item at issue (e.g., “toiletID”), the parts and/or tools needed by the technician (e.g., “plunger, 10 foot snake”), a diagnosis made by the chatbot (e.g., “Local clog”), a minimum skill level of the technician (e.g., “generalist”), a resolution type (e.g., “oneTripTechnician”), an amount of time needed to fix the problem, an estimated cost associated with fixing the problem, user preferences associated with fixing the problem, an estimate cost associated with the technician and/or vendor, an estimated of the tools, parts, and/or corresponding SKUs needed to fix the problem, an identification of the symptom (e.g., “cloggedID”), and/or a recommended solution (e.g., “Snake the toilet”).

The intelligent routing and assignment engine may parse the received work order to extract information that may be used to identify a technician who may perform the maintenance repair job indicated on the work order. To parse the work order, the intelligent routing and assignment engine may use one or more NLP algorithms to identify one or more key words and/or phrases. The one or more NLP algorithms may be supervised machine learning models configured to perform text classification, like k-nearest neighbor (KNN), naive-bayes, XGBoost, catboost, lightGBM, or any other suitable gradient boosting machine learning model. Additionally or alternatively, the one or more NLP algorithms may be an unsupervised machine learning model, such as Lb12Vec or k-means clustering. The one or more NLP algorithms may analyze the text to identify one or more keywords and/or phrases.

In some examples, a first model may be used to identify an item and/or a system. The first model may use named-entity recognition (NER) to identify the item and/or the symptom. A second model (e.g., a second, separate algorithm for NER) may be used to identify a location and/or a component. Both models may be trained using a series of keywords, synonyms, and/or phrases associated with the particular entity/node (e.g., the item, the symptom, the location, or the component). For example, using the named-entity recognition NLP technique, the intelligent routing and assignment engine may scan the work order for one or more diagnosis keys that describe a maintenance repair job (e.g., “itemId,” “diagnosis,” “skillLevelId,” “symptomId,” “recommendedFix,” or the like). The intelligent routing and assignment engine may further scan the work order for one or more values that correspond to the one or more diagnosis keys (e.g., “toiletID,” “Local clog,” “generalist,” “cloggedID,” “Snake the toilet,” or the like).

The intelligent routing and assignment engine may also receive, as input, the price book. The price book may contain locale-based pricing for supplies that may be needed to complete the maintenance repair job as well as the rates for technicians who have the requisite skill set to complete the maintenance repair job. As discussed below, the intelligent routing and assignment engine may use the price book in conjunction with at least one regression model to identify at least one technician who can complete the maintenance repair job. The one or more regression models may be linear (e.g., simple linear regression, multiple linear regression, or the like) or logistic regression models that may be configured to predict, using a series of data inputs, a technician who may complete the maintenance repair job indicated on the work order (or enriched work order). The one or more regression models may use one or more independent and dependent variables. For example, in multiple linear regression models, the one or more independent variables (e.g., one or more predictor variables) may be used to predict the one or more dependent variables (e.g., one or more response variables). In some instances, the one or more independent variables (e.g., one or more predictor variables) may correspond to at least one data input (e.g., a price associated with a technician, the technician's availability, the technician's skill set(s), a rating associated the technician, or the like). In some instances, the one or more dependent variables (e.g., one or more response variables) may correspond to at least one technician who can complete the maintenance job indicated on the work order (or enriched work order). Each of the one or more independent variables (e.g., one or more predictor variables) may be associated with a coefficient (e.g., a weight associated with the one or more independent variables).

While the intelligent routing and assignment engine may use any one of a simple linear regression model, a multiple linear regression model, a logistic regression model, or the like, the present discussion and examples correspond to a multiple linear regression model. The methods and features described herein are not intended to be limiting and can be modified to fit one or more regression models. The multiple linear regression model described herein is solely for illustration purposes.

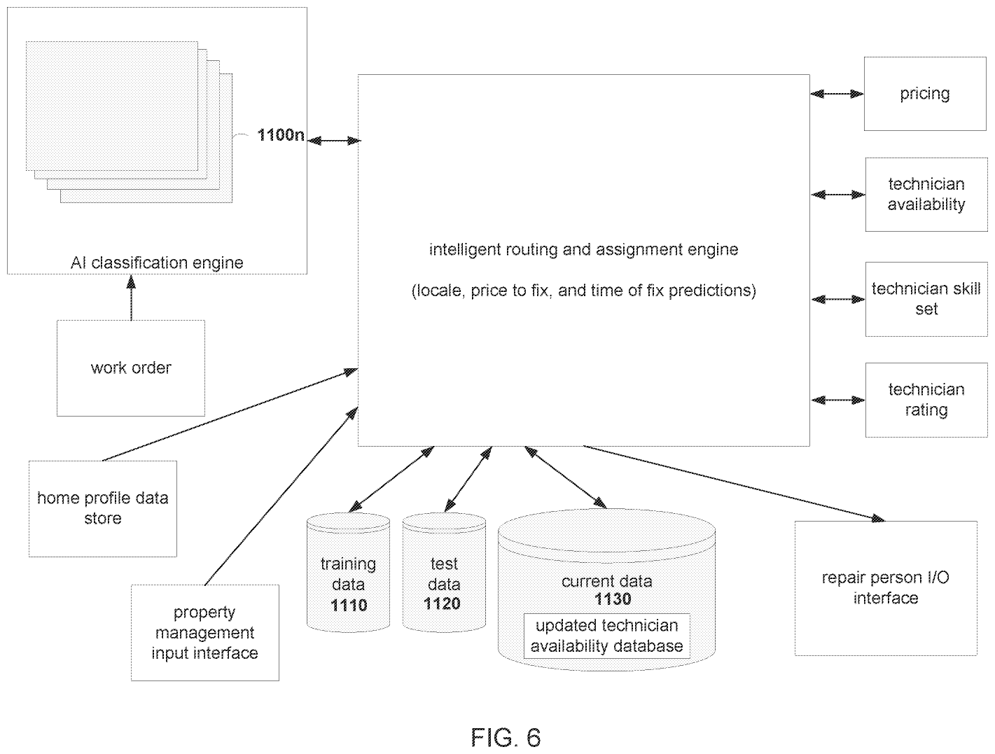

To implement the multiple linear regression model, the intelligent routing and assignment engine may generate training data (e.g., training data 1110 as illustrated in FIG. 6) and may process training data 1110. As discussed above, training data 1110 may be comprised of data inputs that describe a technician (e.g., a price associated with a technician, the technician's availability, the technician's skill set(s), a rating associated with the technician, or the like). The price associated with the technician may indicate the price the technician may charge to complete the maintenance job (e.g., parts, labor, or the like) indicated on the work order (or enhanced work order). The technician's availability may indicate the technician's schedule. The technician's skill set(s) may indicate the extent of the technician's expertise in specific areas (e.g., a pipe replacement expert, a generalist with experience relieving clogs, or the like). The technician's ratings may indicate ratings (e.g., service ratings, performance ratings, or the like) associated with the technician's completion of previous maintenance repair jobs. Training data 1110 may further consist of data inputs that indicate the data extracted from the work order (or enriched work order) by the intelligent routing and assignment engine, as discussed above. Training data 1110 may further consist of the home profile data store that is received by the intelligent routing and assignment engine, as discussed in connection with FIG. 5A. The data within the home profile data store may consist of comprise information about the unit, such as the number of bedrooms, bathrooms, etc. Additionally or alternatively, the home profile data store may comprise information about the equipment and/or machinery located in a unit. The intelligent routing and assignment engine may use the data within the home profile data store to identify a technician who can complete the maintenance repair job indicated on the work order (or enriched work order). For example, the home profile data store may indicate that the water heater associated with the unit is situated in a location that is difficult to reach and, as such, requires a specific set of tools. In such instances, the intelligent routing and assignment engine may determine that a technician with extensive water heater experience and with the requisite tools should be selected to complete the maintenance repair job.

The intelligent routing and assignment engine may continuously update training data 1110 as maintenance repair jobs are routed and assigned to technicians. For example, if a technician associated with a generalist's skill set completes a more complex maintenance repair job (e.g., clog detection and pipe replacement), then the piece of training data 1110 that indicates the technician's skill set may be updated to reflect the technician's experience with remedying clogs. The intelligent routing and assignment engine may study the training data and may learn to identify the independent variables and the dependent variables. The intelligent routing and assignment may separate the training data into more than one datasets (e.g., training data 1110 and test data 1120). For example, the intelligent routing and assignment engine may determine that the data inputs associated with data parsed from the work order (or enriched work order) may correspond to test data 1120 since the data parsed from the work order (or enriched work order) may represent the current maintenance repair job to be assigned to a technician.

The intelligent routing and assignment engine may fit (e.g., code, script, program, or the like) the regression model (e.g., the multiple linear regression model) to training data 1110. To do so, the intelligent routing and assignment engine may use criteria indicated in the price book. As discussed above, the price book may contain locale-based pricing for the maintenance repair job indicated on the work order (or enriched work order) as well as locale-based pricing for supplies that may be needed to complete the maintenance repair job. The intelligent routing and assignment engine may use the price book to estimate the cost associated with the maintenance repair job. The intelligent routing and assignment engine may fit the data from the price book to training data 1110 such that the regression model may determine how to filter training data 1110. For example, if the price book indicates that the locale-based cost of repairing a localized clog is X, then the intelligent routing and assignment engine may filter training data 1110 to represent technicians who charge the locale-based price or less than the locale-based price.

The intelligent routing and assignment engine may further fit the regression model to training data 1110 using time-to-fix criteria. The time-to-fix criteria may indicate the average time needed to complete the maintenance repair job indicated on the work order (or enriched work order) based on previous maintenance repair jobs of the same nature. In some instances, the time-to-fix may further indicate each technician's projected time-to-fix the maintenance repair job. The intelligent routing and assignment engine may fit the time-to-fix data to training data 1110 such that the regression model may determine how to filter training data 1110. For example, if the time-to-fix data indicates that the time to repair a localized clog is approximately four hours, then the intelligent routing and assignment engine may filter training data 1110 to represent technicians who take four or less than four hours to complete the maintenance repair job indicated on the work order (or enriched work order).

The intelligent routing and assignment engine may continuously train the regression model as the intelligent routing and assignment engine receives updated data (e.g., updated time-to-fix data, updated price book data, new/updated work orders (or enriched work orders), or the like). The intelligent routing and assignment engine may continuously determine the accuracy of the regression model using test data 1120. As discussed above, test data 1120 may consist of the data that was parsed from the work order (or enriched work order) by the intelligent routing and assignment engine. The intelligent routing and assignment engine may modify the accuracy of the regression model using feedback from the technician, as discussed below. The intelligent routing and assignment engine may use the feedback from the technician to determine whether a technician should be assigned particular work orders (or enriched work orders). The intelligent routing and assignment engine may continuously update test data 1120 as the intelligent routing and assignment engine receives new work orders (or enriched work orders). The intelligent routing and assignment engine may run the regression model to predict at least one technician who can complete the maintenance repair job indicated on the work order (or enriched work order).

The intelligent routing and assignment engine may transmit the work order (or enriched work order) to the technicians selected by the regression model. Technicians may receive the work order (or enriched work order) using a computing device with an I/O interface (e.g., a tablet, laptop, cellular phone, or the like). The technician assigned to the work order (or enriched work order) may review the work order and may provide feedback accordingly. For example, the technician may confirm whether the diagnosis indicated on the work order (or the enriched work order) corresponds to the technician's diagnosis upon on-site inspection. In some instances, the technician may use the I/O interface of the computing device to indicate that the information on the work order corresponds to the problem associated with the item (e.g., product, appliance, unit, or the like) indicated on the work order (or enriched work order). In some instances, the technician may use the I/O interface of the computing device to indicate that the information on the work order does not correspond to problem associated with the item, and may use the I/O interface of the computing device to describe the errors on the work order (or enriched work order).

The intelligent routing and assignment engine may receive, from the I/O interface of the computing device associated with the technician, the feedback from the technician. The intelligent routing and assignment engine may use the feedback from the technician to modify the training data. For example, if the technician indicates that the maintenance repair job is better suited for specialist skill set and not a generalist skill set, then the intelligent routing and assignment engine may use the feedback from the technician to update the skill set needed to complete the maintenance repair job on future work orders (or enriched work orders). The intelligent routing and assignment engine may continuously listen for feedback from technicians and may use the feedback to continuously update the training data.

The feedback from the technician may also be transmitted to the processing component of the computing system employing the artificial intelligence-driven chatbot, as described in connection with FIG. 5A. The processing component may use the feedback from the technician to train the problem classification engine, the troubleshooting and diagnosis engine, and the recommendation engine, each of which are described in connection with FIG. 5A. The problem classification engine may use the feedback from the technician to train (e.g., change, modify, update, or the like) the one or more NLP algorithms that the problem classification engine may use to perform text classification. The one or more NLP algorithms may be supervised machine learning models configured to perform text classification, like k-nearest neighbor (KNN), naive-bayes, XGBoost, catboost, lightGBM, or any other suitable gradient boosting machine learning model. Additionally or alternatively, the one or more NLP algorithms may be an unsupervised machine learning model, such as Lb12Vec or k-means clustering.

The troubleshooting and diagnosis engine may use the feedback from the technician to better identify the problem statement from the user's original input. In particular, the troubleshooting and diagnosis engine may use the feedback from the technician to train one or more NLP algorithm that may be used to identify the item, the symptom, the location, and/or the component. Additionally or alternatively, the troubleshooting and diagnosis engine may use the updated NLP algorithms to determine whether the user input comprises enough information to begin troubleshooting and diagnosing the problem. In another alternative, the troubleshooting and diagnosis engine may use the updated NLP algorithms to determine whether the user input comprises a general symptom (e.g., being broken) or a prime symptom (e.g., broken in a specific way). Based on the analysis of the input (e.g., whether it identifies an item, a symptom, a location, and/or a component; whether it contains enough information; whether it identifies a prime symptom, etc.), the troubleshooting and diagnosis engine may select a conversational pathway.

The recommendation engine may use the feedback from the technician to tailor the proposed solution(s) to the maintenance problem reported by the user. To do so, the recommendation engine may use the output of the problem classification engine and the output of the troubleshooting and diagnosis engine, both of which may use the feedback from the technician to train one or more NLP algorithms.

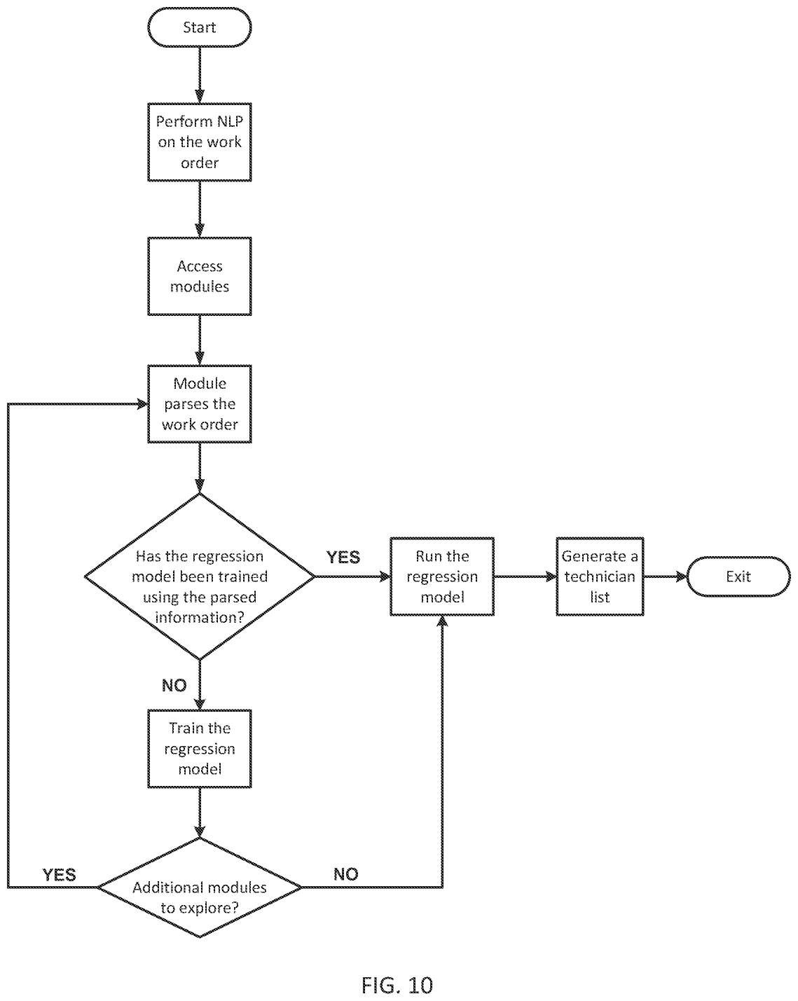

FIG. 10 depicts a flowchart for generating a list of potential technicians to perform the maintenance repair job indicated on the work order. As discussed in connection with FIG. 9, the intelligent routing and assignment engine may receive the work order (or the enriched work order) that is generated by the chatbot, as well as the price book and time-to-fix data. The work order (or enriched work order) may contain information collected by the chatbot and from the user. The information collected by the chatbot may include an identification of the problem (e.g., “Toilet-Clogged-Local”), the item at issue (e.g., “toiletID”), the parts and/or tools needed by the technician (e.g., “plunger, 10 foot snake”), a diagnosis made by the chatbot (e.g., “Local clog”), a skill level of the technician (e.g., “generalist”), a resolution type (e.g., “oneTripTechnician”), an identification of the symptom (e.g., “cloggedID”), and/or a recommended solution (e.g., “Snake the toilet”).

The intelligent routing and assignment engine may parse the received work order to extract information that may be used to identify a technician who may perform the maintenance repair job indicated on the work order. To parse the work order, the intelligent routing and assignment engine may use one or more NLP algorithms to identify one or more key words and/or phrases. The one or more NLP algorithms may be supervised machine learning models configured to perform text classification, like k-nearest neighbor (KNN), naive-bayes, XGBoost, catboost, lightGBM, or any other suitable gradient boosting machine learning model. Additionally or alternatively, the one or more NLP algorithms may be an unsupervised machine learning model, such as Lb12Vec or k-means clustering. The one or more NLP algorithms may analyze the text to identify one or more keywords and/or phrases.

In some examples, a first model may be used to identify an item and/or a system. The first model may use named-entity recognition (NER) to identify the item and/or the symptom. A second model (e.g., a second, separate algorithm for NER) may be used to identify a location and/or a component. Both models may be trained using a series of keywords, synonyms, and/or phrases associated with the particular entity/node (e.g., the item, the symptom, the location, or the component). For example, using the named-entity recognition NLP technique, the intelligent routing and assignment engine may scan the work order for one or more diagnosis keys that describe a maintenance repair job (e.g., “itemId,” “diagnosis,” “skillLevelId,” “symptomId,” “recommendedFix,” or the like). The intelligent routing and assignment engine may further scan the work order for one or more values that correspond to the one or more diagnosis keys (e.g., “toiletID,” “Local clog,” “generalist,” “cloggedID,” “Snake the toilet,” or the like).

In some instances, the intelligent routing and assignment engine may utilize a plurality of modules to perform further NLP on the work order (or enriched work order). In some instances, the intelligent routing and assignment engine may transmit the information that was parsed from the work order to a pricing module. The pricing module may use one or more NLP algorithms to identify one or more key words and/or phrases. The one or more NLP algorithms may be supervised machine learning models configured to perform text classification, like k-nearest neighbor (KNN), naive-bayes, XGBoost, catboost, lightGBM, or any other suitable gradient boosting machine learning model. Additionally or alternatively, the one or more NLP algorithms may be an unsupervised machine learning model, such as Lb12Vec or k-means clustering. The one or more NLP algorithms may analyze the text to identify one or more keywords and/or phrases. For example, the pricing module may use one or more NLP algorithms to scan the work order (or enriched work order) for a diagnosis (e.g., “Local clog”), a recommended solution to the diagnosis (e.g., “Snake the toilet”), and customer preferences that indicate an amount that the customer is willing to spend to complete the maintenance repair job (e.g., “less than X dollars”). The intelligent routing and assignment engine may add the information that is parsed from the work order (or enriched work order) to test data 1120. The regression model may use the data parsed from the work order (or enriched work order) to determine whether the customer's price preference falls within the price range that is typically charged for the maintenance repair job indicated on the work order (or enriched work order).

The intelligent routing and assignment engine may determine whether there are additional modules (e.g., a technician availability module, a technician skill set(s) module, a technician rating module, or the like) that may be used to identify a potential technician. If there are additional modules, then the intelligent routing and assignment engine may transmit the work order to the additional modules such that the additional modules may parse the work order (or enriched work order). The intelligent routing and assignment engine may use the information parsed by the additional modules to further train the regression model. The intelligent routing and assignment engine may run the regression model and may generate a list of technicians.

FIG. 6 illustrates an example embodiment of a supervised machine learning engine, wherein a data store (e.g., graph database) may store the relationships between collected training data 1110, test data 1120, current data 1130, and other inputs. A supervised machine learning model may provide an indication to a graph module interfacing with the graph database that output from the ML model was correct and/or incorrect. In response to that indication, the graph module may update the graph database to improve the accuracy of the regression model and of the predictions. The modifications may be based on historical data, a feedback loop, or based on information that is received from an external source, such as customer preferences or rules sets, another computing device (e.g., a technician computing device), or the like.

Where feedback is received and causes the intelligent routing and assignment engine to adjust the way in which work orders (or enriched work orders) are routed and assigned to technicians, the machine learning model may be referred to as a supervised machine learning model. Although the aforementioned example refers to a graph database, the disclosure is not so limited. Other forms and types of data stores may be used with the intelligent routing and assignment engine to assist in generating a list of technicians who are able to complete the maintenance repair job indicated on the work order (or enriched work order) based on information that may be parsed from the work order (or enriched work order). For example, pathways 1100n (e.g., programmatic rule sets) in the AI classification engine may be combined with data extracted from the work order (or enriched work order) to suggest at least one technician who is capable of completing the maintenance repair job indicated on the work order (or enriched work order).

In supervised learning, a machine learning algorithm is provided feedback on its output. Feedback may be provided in a variety of ways, including via active learning, semi-supervised learning, and/or reinforcement learning, as described above. In active learning, a machine learning algorithm is allowed to query answers from an administrator. For example, the intelligent routing and assignment engine may, solely or in coordination with other algorithms, models, or modules, identify a technician who is capable of completing the maintenance repair job. Similar to the NLP algorithms described herein, one or more models may parse the work order (or enriched work order) to predict whether the criteria indicated on the work order (or enriched work order) corresponds to technicians who were previously assigned a work order (or enriched work order). In some examples, a first model may be used to determine whether the customer's preferred price range is within the industry price range for the maintenance repair job indicated on the work order (or enriched work order). In some examples, a second model may be used to determine the schedules and availability of technicians who can complete the maintenance repair job indicated on the work order (or enriched work order). In some examples, a third model may be used to determine the skill set of the technicians who are available to complete the maintenance repair job indicated on the work order (or enriched work order). In some examples, a fourth model may be used to determine whether the ratings associated with the available technicians satisfy the customer's rating preferences. More or less models (e.g., three models, five models, seven models, or more models) may be used in coordination. Then, the intelligent routing and assignment engine may use the actual input from the repair person (e.g., technician) input/output (I/O) interface to compare the generated prediction to that of the administrator/supervisor. The intelligent routing and assignment engine may adjust the confidence value of its predictions and adjust weights accordingly.

Meanwhile, in reinforcement learning, the machine learning algorithm is rewarded for correctly predicting technicians who can complete the maintenance repair job indicated on the work order (or enriched work order). For example, the machine learning algorithm may be given a point and/or a score (e.g., “85% correct”) for each work order (or enriched work order) that is correctly routed and assigned to a technician whose price satisfies the customer's price preference, who is available to complete the maintenance repair job, who has the appropriate skill level to complete the maintenance repair job, whose rating satisfies the customer's rating preference, or the like.

In some examples, the intelligent routing and assignment engine may identify relationships between nodes (e.g., in a graph database) that previously may have gone unrecognized. For example, using a collaborative filtering technique, the intelligent routing and assignment engine may identify that a node indicating an increase in the industry price range for a particular maintenance repair job should be used by the one or more regression models. The intelligent routing and assignment engine may determine that the price range associated with the repair maintenance job has changed and may modify the weight of the price node (e.g., the coefficient of the data input used by the regression model) and may subsequently adjust the weight of adjacent/connected nodes. This may result in particular nodes adjusting their confidence values/scores to push those nodes to an updated outcome from a Boolean false to a Boolean true. Other examples of machine learning techniques may be used in combination or in lieu of a collaborative filtering technique.

Regarding unsupervised anomaly detection, the intelligent routing and assignment engine (e.g., an unsupervised intelligent routing and assignment engine) may construct feature vectors using the data store (e.g., graph database). For example, each node (e.g., price, availability, skill set, rating, or the like) and its associated edges may be converted into a feature vector. An unsupervised feature vector may include data about each node stored in a historical data store, current data store, training data store, and/or other data store. An unsupervised feature vector may also include a score. The score may represent the confidence score of the node. The feature vector may also include current data. For example, the feature vector may include data related to ongoing repair data of the corresponding node. The unsupervised intelligent routing and assignment engine may use the unsupervised feature vectors in a machine learning algorithm to detect anomalies within the graph. The unsupervised intelligent routing and assignment engine may use any machine learning model to detect anomalies within the graph including support vector machines, isolation forest model, K-nearest neighbors (KNN), Naive Bayes (NB), and/or other techniques. For example, the unsupervised intelligent routing and assignment engine may use a clustering technique to cluster the unsupervised feature vectors to determine whether any of the nodes are exhibiting unusual behavior/symptoms. The unsupervised intelligent routing and assignment engine may use any clustering algorithm (e.g., K-means, affinity propagation, mean-shift, spectral clustering, Ward hierarchical clustering, agglomerative clustering, density-based spatial clustering of applications with noise (DBSCAN), Gaussian mixtures, Birch, shared nearest neighbors, etc.). The clustering algorithm may use a distance metric such as Euclidean distance, Manhattan distance, cosine distance, etc. to determine distances between unsupervised feature vectors when clustering. The unsupervised intelligent routing and assignment engine may determine that some clusters are anomalous because of their differences from other clusters.

In one example, the unsupervised intelligent routing and assignment engine may use an autoencoder technique to detect anomalies within the graph. The autoencoder may be constructed with a number of layers that represent the encoding portion of the network and a number of layers that represent the decoding portion of the network. The encoding portion of the network may output a vector representation of inputs into the encoder network, and the decoding portion of the network may receive as input a vector representation generated by the encoding portion of the network. It may then use the vector representation to recreate the input that the encoder network used to generate the vector representation. The autoencoder may be trained on historical data or feature vectors that are known to not be anomalous. By training on non-anomalous feature vectors, the autoencoder may learn how a non-anomalous node behaves. When the autoencoder encounters a feature vector that is different from the feature vectors it has trained on, the unsupervised diagnosis engine may flag the feature vector as potentially anomalous. In some examples, the autoencoder may be a variational autoencoder. The variational autoencoder may include the components of the autoencoder. The variational autoencoder may also include a constraint on its encoding network that forces it to generate vector representations of inputs according to a distribution (e.g., a unit Gaussian distribution). In other examples, the unsupervised diagnosis engine may use other techniques like Tensorflow-Keras neural networks and bidirectional encoder representation and transformers (BERT) encodings.

A graph representation of nodes and relationships may be analyzed by an unsupervised machine learning model. As discussed in greater detail above, an unsupervised machine learning model may be used to determine, among other things, correlations in data sets without external feedback (e.g., a score associated with machine learning output). Such an unsupervised machine learning model may be executed on a graph representation of nodes and relationships in order to determine, for example, how a characterization of one node (e.g., a determination of a flaw or error in one node) may adjust the confidence value associated with connected nodes.

An unsupervised machine learning model may analyze a graph representation using definitional functions. Definitional functions may comprise, for example, a definition of the relationship between two nodes and/or the definition of a node. A definitional function may be, for example, descriptive (e.g., describing a technician's skill set), quantitative (e.g., describing numerically the degree of similarity between a first technician's skill set as compared to a second technician's skill set), and/or qualitative. An unsupervised machine learning model may use definitional functions defining a node to determine how weights associated with a node may originate and adjust the weight of related nodes. A definitional function may influence how an unsupervised machine learning model interprets a quantity and/or characterization involving a node. For example, a definitional function may indicate that a particular skill set is needed to complete a particular maintenance repair job, which is published in an accessible data store (e.g., a current data store). As such, the unsupervised machine learning model may use this definitional rule, in conjunction with input data, to calculate that risk is marginally more likely (or significantly more or less likely) in some circumstances (e.g., the risk of a failed maintenance repair job is significantly more likely when a technician who does not have the requisite skill set is assigned to the particular maintenance repair job).

An unsupervised machine learning model need not obey a definitional function or treat a definitional function as fact. In addition to or alternatively from the definitional functions, each node in a given graph representation of one or more maintenance repair jobs may be associated with one or more machine learning models, such that the graph representation may be associated with a limitless number of machine learning models. Each machine learning model may be supervised and/or unsupervised, and may be configured in any of the manners described above. Each node and/or class of nodes may be associated with one or more machine learning models which may make decisions with regard to the graph and/or with regard to risk. For example, one node may have a supervised machine learning model using a first set of definitional functions, whereas another node may have an unsupervised machine learning model using a second set of definitional functions. As another example, a class of nodes (e.g., technician availability) may be associated with a first type of machine learning model, whereas a second class of nodes (e.g., technician skill set) may be associated with a set of machine learning models configured to operate in series and/or in parallel.

Multiple machine learning models may be used together to make decisions. The output of one machine learning model may be used as the input of another machine learning model, and/or multiple machine learning models may execute in parallel, such that decision-making may comprise the use of a limitless number of machine learning models. While the disclosure contemplates numerous different approaches to implementing the disclosed system, in one example, the system may be implemented through server-side components, client-side components, and objects. For example, see FIG. 6, which illustrates just one example of a sample network configuration of the components/modules/systems interacting. Other configurations and interactions are contemplated and the illustration of FIG. 9 is not meant to be limiting.

As further illustrated in FIG. 6, the intelligent routing and assignment engine may receive input from a plurality of sources, including an AI classification engine, a training data database, a test data database, a current data database, a repair person (e.g., technician) I/O interface, or the like. As discussed in connection with FIG. 9, the intelligent routing and assignment engine may parse the work order (or enriched work order) generated by the chatbot (e.g., using the AI classification engine) using one or more NLP algorithms. The intelligent routing and assignment engine may use the information that was parsed from the work order (or the enriched work order) as well as a plurality of modules to train a regression model to identify a technician who can complete the maintenance repair job indicated on the work order (or the enriched work order).

To do so, the intelligent routing and assignment engine may use training data 1110 and test data 1120 to identify a technician who can complete the maintenance repair job indicated on the work order (or the enriched work order). The training data database may contain data that was parsed from previous work order (or enriched work order) assignments. For example, training data 1110 may contain a data structure comprised of a plurality of technicians, descriptions of the technicians (e.g., each technician's skill level and ratings), work orders (or enriched work orders) that each technician completed, or the like. Training data 1110 may also contain synthetic training data to assist the intelligent routing and assignment engine with training the regression model and with determining how to assign work orders (or enriched work orders) to technicians. For example, the intelligent routing and assignment engine may use the synthetic training data to identify patterns in assigning a particular group of work orders to a particular type of technician.

The current data database may contain updated changes (e.g., modifications, additions, or the like) to the industry pricing of maintenance repair jobs, technician scheduling and availability, technician skill sets, technician ratings, or the like. The intelligent routing and assignment engine may use current data 1130 to further train the regression model to determine whether a technician can complete the maintenance repair job indicated on the work order (or enriched work order). For example, current data 1130 may contain an updated technician availability database, which may indicate whether a technician's schedule has added availability, limited availability, or the like.

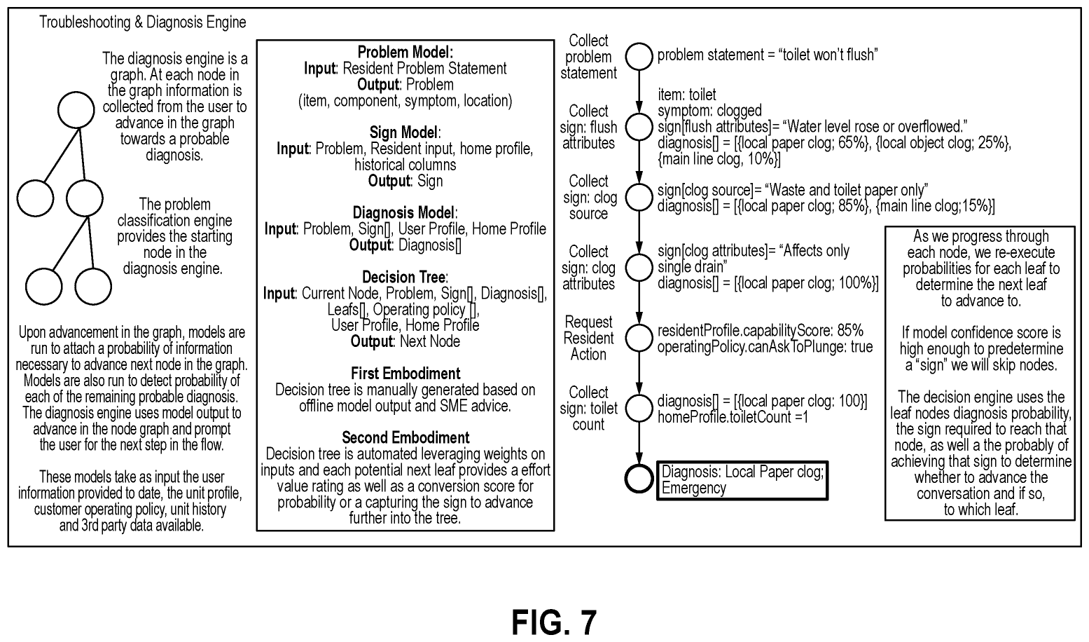

FIG. 7 illustrates a plurality of example regression models that may be used by the troubleshooting and diagnosis engine to diagnose the problem, troubleshoot the problem, and/or generate a work order (or enriched work order) that may be used to locate a technician capable of resolving the problem. As discussed above, the troubleshooting and diagnosis engine may receive, from the problem classification engine, one or more inputs (e.g., user input and/or description(s) of the problem, or the like) and may analyze the one or more inputs to determine a conversational pathway that may be used to converse with the user and/or to troubleshoot and diagnose the problem. To determine a conversational pathway, the troubleshooting and diagnosis engine may use a node graph comprised of a plurality of nodes, wherein the input and/or output of each node may be used to progress through the node graph and/or to diagnose the problem (e.g., a maintenance issue, or the like). The node graph may comprise a plurality of regression models and each regression model is described in detail below.

The initial node of the node graph may correspond to the one or more inputs received from the problem classification engine. The initial node may also correspond to a first regression model (e.g., a problem model, or the like). The problem model may parse the one or more inputs (e.g., the user statement and/or description of the problem, or the like) using at least one NLP algorithm, as described above. Moreover, the problem model may use at least one large language model (LLM) (e.g., BERT, GPT, Dialogflow, or the like) to classify the data within the one or more inputs, to generate a vectorization structure that may be used to progress through the node graph, to perform entity recognition, or the like. Each LLM may be tailored and trained using tuning parameters to identify problems that a user may experience (e.g., maintenance issues, household equipment and/or machinery repairs, commercial equipment and/or machinery repairs, industrial equipment and/or machinery repairs, or the like). The tuning parameters may comprise various descriptions of a plurality of problems as well as categorizations that correspond to each problem. For example, at least one LLM may be configured to recognize “ac,” “aircon,” “air conditioning,” “HVAC,” “window unit,” or “temp unit” as alternative indications of an air conditioning system and/or as alternative indications of a heating and cooling system. Each LLM may be trained (e.g., continuously trained, or in some examples, intermittently trained) and/or modified using user input as training data. Further, each LLM may be trained using at least one traditional machine learning algorithm (e.g., multinomial Naive Bayes, K-nearest neighbor, the regression model described herein, or the like), as discussed above.

Based on the parsing and/or the at least one LLM, the problem model may identify the problem, wherein the identification of the problem may comprise at least one item associated with the problem, at least one component of the at least one item, at least one symptom of the at least one item, and/or a location of the at least one item. The output of the problem model (e.g., the problem, the output of the first regression model, the output of the initial node, or the like) may progress to the next level of nodes within the node graph.

For example, the system described herein may be configured to operate as a toilet maintenance system wherein the problem node may determine, based on a toilet maintenance request from the user, that the problem is a toilet that does not flush. From the user description, the problem node may determine the item associated with the problem is a toilet and the symptom associated with the toilet is a clog. In some embodiments, the problem node may identify more than one possible symptom of the item and may transmit a plurality of symptoms to a sign model to further pinpoint the symptom that corresponds to the item. For example, in accordance with the current example, the problem node may determine that the plurality of symptoms of the toilet comprise a clogged toilet, a malfunctioning flapper, an interference with a water supply, or the like. The problem node may transmit the problem to the subsequent nodes.

The next level of nodes within the node graph may correspond to a second regression model (e.g., the sign model, or the like). The sign model may receive, as input, the output from the problem model (e.g., the problem). The sign model may also use, as input, the home profile information associated with the user. In some embodiments, the sign model may use, as input, historical data generated during previous iterations of the regression models described herein.

The sign model may use at least one NLP algorithm to further parse the problem and/or to converse with the user. In particular, the sign model may gather data that describes signs that suggest there is a problem. In embodiments where the problem node identified the plurality of symptoms, the sign model may converse with the user to narrow down the symptom and/or to identify the signs associated with the symptom. The output of the sign model (e.g., the sign(s) of the problem, the output of the second regression model, or the like) may progress to the next level of nodes within the node graph.

For example, in accordance with the example above, the sign model may receive the plurality of toilet symptoms from the problem model. The sign model may identify, based on historical data generated through previous iterations of the regression models described herein, previously identified signs associated with previous toilet problems that may be similar to the current toilet problem. The sign model may determine that, historically, users identified the toilet's inability to flush based on a lack of water in the toilet, an increase in the water level within the toilet, an overflow of the water within the toilet, or the like. The sign model may transmit the signs to the subsequent nodes within the node graph.

The subsequent nodes within the node graph may correspond to a third regression model (e.g., a diagnosis model, or the like). The diagnosis model may receive, as input, the problem, the sign(s), the home profile information associated with the user, and/or a user profile associated with the user. The diagnosis model may use the received problem and the home profile information to identify a location of the item (e.g., geographic location of the user home, a location of the item within the user home, or the like) and/or to use data that describes the location to generate a diagnosis. In some embodiments, the diagnosis model may use the user profile to analyze previous problems that the user experienced and/or to determine whether the current problem may be symptomatic of at least one previous problem experienced by the user. Further, in some embodiments, the diagnosis model may determine, based on parsing the user profile associated with the user (and/or additional user profiles associated with additional users), that the user (and/or additional users) previously experienced the problem.

In doing so, the diagnosis model may generate a numeric (quantitative) description of the problem (e.g., a frequency of the problem, a numeric indication of a severity of the problem, a rank associated with the severity of the problem, bounding parameters of the problem, or the like). The diagnosis model may store, within the system described herein, the quantitative description of the problem (e.g., as training data, or the like) and may use the training data to continuously train the plurality of regression models. Continuously training the regression models may prepare the regression models to readily diagnosis future problems based on the presence (or absence) of symptoms and/or signs.

The diagnosis model may use the quantitative description of the problem as the basis of further conversation with the user (e.g., to identity the most likely root cause of the problem, or the like). Based on identifying the root cause (or most likely root cause) of the problem, the diagnosis model may inquire whether the user is able (e.g., has appropriate tools, is physically capable, or the like) to manually resolve the problem using at least one suggested remedy. The diagnosis model may use the conversation with the user and the accompanying quantitative values to determine a level of urgency associated with the problem (e.g., whether the user is unable to manually resolve the problem rendering the problem an emergency, whether the user is able to manually resolve the problem in a timely manner, or the like). Based on the conversation with the user and the analysis performed herein, the diagnosis model may update the user profile, the home profile information, and/or the training data. The output of the diagnosis model (e.g., the diagnosis, or the like) may be used to generate the work order (or the enriched work order) and/or to troubleshoot the problem.

For example, in accordance with the above example, the diagnosis model may analyze each sign to determine a root cause of the toilet's inability to flush. The diagnosis model may parse the user profile and/or additional user profiles to determine whether the user and/or the additional users previously reported a toilet that did not flush. Based on determining the problem was previously experienced, the diagnosis model may analyze previous diagnoses associated with the previously experienced, similar problems to generate the quantitative description of the current problem. In doing so, the diagnosis model may determine that when a toilet is unable to flush, the root cause in 65% of the reported problems is a local clog caused by a paper product, the root cause in 25% of the reported problems is a local clog caused by an object other than paper products, and the root cause in the remaining 10% of the reported problems is a clog in a main plumbing line. The diagnosis model may transmit, to the user, further questions about the toilet and the clog, and may determine that the clog is caused by either a local paper product clog or a main plumbing line clog. Based on further conversation with the user regarding the number of toilets and/or drains affected by the problem, the diagnosis model may determine the problem affects a single drain and, as such, the root cause of the problem is a local clog caused by paper products. The diagnosis engine may question the user on whether the user has the appropriate tools and/or capability to manually unclog the toilet. Based on the user's response, the diagnosis model may assist the user with troubleshooting the problem and/or generating a work order (or an enriched work order) to enlist the assistance of a technician to fix the toilet.

In some embodiments, and over time, the training data used to train the plurality of regression models may increase exponentially (e.g., as users report more problems, as more problems are diagnosed using the methods described herein, or the like). Consequently, the accuracy of the regression models may continuously increase and a confidence value associated with each diagnosis may also continuously increase.

Furthermore, in some embodiments, the system described herein may utilize a plurality of techniques to translate the output of each regression model into quantitative data that may be fed back into subsequent regression models. In particular, the system described herein may use at least one of TF-IDF, count vectorizer, bespose LLM vectorizers, or the like to facilitate the vectorization of the problem, the vectorization of the outputs of the conversational pathways, or the like. In some embodiments, the system described herein may utilize rule-based models to facilitate the conversational pathways within the node graph and/or to troubleshoot and diagnose the problem.

Aspects of the invention have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the invention.

Although numerous examples are directed to a house/apartment/home, the disclosure is not so limited. Rather, the disclosed systems contemplate being modified to be used to diagnose and troubleshoot components, items, and/or systems other than those simply in/associated with a house/apartment/home. For example, the engines illustrated in FIG. 5B may be specifically trained and then executed on input data for repairing automobiles, motorcycles, and/or other vehicles. In such an embodiment, the training data store in FIG. 5B may comprise componentlD, itemID, locationID, symptomID, and other feature IDs that correspond to vehicle maintenance and/or repair. Meanwhile, the disclosure contemplates other systems with multiple components that may be repaired and/or maintained using the cooperating engines illustrated in FIG. 5B.

Although several of the apparatuses and/or systems in the disclosure are labeled in upper case, they are not intended to describe a single apparatus or system. For example, the Problem Classification Engine is interchangeable with a problem classification engine that fits the functional, technical, and operational requirements of a problem classification engine as described in this disclosure.

Finally, this disclosure contemplates and discloses a non-transitory computer-readable storage medium having computer-executable program instructions stored thereon that when executed by a processor, cause the processor to perform one or more of the method steps described above. Moreover, this disclosure contemplates and discloses an apparatus comprising: (1) a processor, and (2) a memory having stored therein computer executable instructions, that when executed by the processor, cause the apparatus to perform one or more of the method steps described above.

The following paragraphs (CP1) through (CP13) describe examples of computing platforms that may be implemented in accordance with the present disclosure.

(CP1) An artificial intelligence (AI) computing platform comprising: at least one processor; a communication interface communicatively coupled to the at least one processor; and memory storing computer-readable instructions that, when executed by the at least one processor, cause the AI computing platform to: receive, by a chatbot associated with an input component and from a user device, data that describes a maintenance issue; transmit, via the chatbot and to the user device, at least one remedy for the maintenance issue; based on receiving, from the user device, an indication that the at least one remedy failed, analyze, by a processing component, the data; generate, by the processing component and based on the analyzing, a work order; generate, based on the data and the work order, training data; implement a machine learning algorithm to train, using the training data, a plurality of regression models to identify a plurality of technicians to resolve the maintenance issue; transmit, by a fulfillment component, an enriched work order to at least one technician or the plurality of technicians; receive feedback from the at least one technician, wherein the feedback indicates an accuracy of the enriched work order; and update the machine learning algorithm using the feedback.

(CP2) The AI computing platform as described in (CP1), wherein the generating the work order further comprises configuring a troubleshooting and diagnosis engine to identify at least one of: the maintenance issue; at least one item that corresponds to the maintenance issue; at least one tool to be used to repair the item; a diagnosis of the maintenance issue; a technician skill level needed to repair the item; an identification of at least one symptom; or a proposed solution.

(CP3) The AI computing platform as described in (CP2), wherein the generating the work order further comprises using at least one natural language processing (NLP) algorithm, wherein the NLP algorithm comprises at least one of a supervised machine learning model or an unsupervised machine learning model.

(CP4) The AI computing platform as described in (CP2), wherein the instructions, when executed, further cause the computing platform to store home profile information, wherein the home profile information indicates at least one of: a layout of a home that corresponds to the maintenance issue; a geographic location of the home; an identification of a type of home; a description of equipment stored within the home; or a description of machinery stored within the home.

(CP5) The AI computing platform as described in (CP4), wherein the generating the work order is further based on analyzing the home profile information that corresponds to the maintenance issue.

(CP6) The AI computing platform as described in (CP5), wherein the training data comprises at least one of: a description, generated by the user device, of at least one item that corresponds to the maintenance issue; a description, generated by the user device, of at least component of the item; a description, generated by the user device, of a symptom of the item; or the home profile information.

(CP7) The AI computing platform as described in (CP1), wherein the processing component further comprises an intelligent routing and assignment engine configured to generate an enriched work order.

(CP8) The AI computing platform as described in (CP7), wherein the enriched work order comprises at least one of: a diagnosis that describes the maintenance issue; tools needed to resolve the maintenance issue; parts needed to resolve the maintenance issue; a minimum technician skill level needed to resolve the maintenance issue; an amount of time needed to resolve the maintenance issue; an estimated cost of resolving the maintenance issue; consumer computing device preferences associated with resolving the maintenance issue; an estimated cost of the tools and parts needed to resolve the maintenance issue; an estimated cost associated with a technician; and consumer computing device preferences associated with resolving the maintenance issue.

(CP9) The AI computing platform as described in (CP8), wherein the intelligent routing and assignment engine is further configured to train at least one regression model based on at least one of: the enriched work order; the home profile information; a price book, wherein the price book comprises locale-based pricing that corresponds to the maintenance issue; or an estimated amount of time to fix the maintenance issue.

(CP10) The AI computing platform as described in (CP1), wherein the processing component further comprises an AI problem classification engine configured to execute a supervised learning model using the training data.

(CP11) The AI computing platform as described in (CP10), wherein the supervising learning module receives, as input, at least one of: subject matter expert classifications; subject matter expert diagnoses; and subject matter expert recommendations.

(CP12) The AI computing platform as described in (CP1), wherein the instructions, when executed, further cause the computing platform to generate a vector representation of a plurality of maintenance issues, wherein each maintenance issue of the plurality of maintenance issues corresponds to at least one user device of a plurality of user devices.

(CP13) The AI computing platform as described in (CP12), wherein each vector within the representation corresponds to a different maintenance issue, wherein each different maintenance issue is associated with a weight, and wherein the weight indicates a popularity of the different maintenance issues.

(CP14) The AI computing platform as described in (CP1), wherein the plurality of regression models comprises a first regression model, and wherein the first regression model is configured to perform entity recognition to identify: an item associated with the maintenance request and symptoms of the item.

(CP15) The AI computing platform as described in (CP14), wherein the first regression model uses large language models (LLMs) to generate a vectorization structure, wherein the vectorization structure comprises a node graph.

(CP16) The AI computing platform as described in (CP15), wherein the node graph comprises a plurality of conversational pathways and wherein progression through the conversational pathways is based on outputs of each regression model of the plurality of regression models.

(CP17) The AI computing platform as described in (CP1), wherein the plurality of regression models comprises a second regression model, and wherein the second regression model is configured to identify signs that correspond to a root cause of the maintenance request.

(CP18) The AI computing platform as described in (CP1), wherein the plurality of regression models comprises a third regression model, and wherein the third regression model is configured to diagnose and troubleshoot the maintenance request.

(CP19) The AI computing platform as described in (CP18), wherein diagnosing the maintenance request further comprises determining a quantitative description of the maintenance request, wherein the quantitative description comprises: a frequency of the maintenance request, a numeric indication of a severity of the maintenance request, a rank associated with the severity of the maintenance request, and bounding parameters of the maintenance request.

What is claimed is:

1. A toilet maintenance chatbot system comprising:
a user device;
a toilet;
a technician device; and
a computing device comprising a processor and a non-transitory memory device storing instructions that, when executed by the system, cause the system to:
receive, from the user device, a toilet maintenance request;
generate, based on inputting the toilet maintenance request into one or more machine learning models, one or more messages to identify:
the make of the toilet,
symptoms of the toilet,
a location of the toilet, and
components of the toilet that require repair;
transmit, to the user device, the one or more messages;
receive, from the user device, one or more responses to the one or more messages;
based on the one or more responses meeting an information threshold, generate, based on inputting the toilet maintenance request and the one or more responses into the one or more machine learning models, a solution to remediate issues with the toilet;
send, to the user device, the solution to remediate the issues with the toilet;
based on receiving, from the user device, an indication that the solution failed, generate a work order that corresponds to the toilet maintenance request;
generate training data based on the work order, an enriched work order, and the one or more responses;
implement a machine learning algorithm to train, using the training data, a plurality of regression models to identify a plurality of technicians;
transmit the work order to the technician device associated with a technician of the plurality of technicians; and
receive, from the technician device, feedback indicating an accuracy of the work order.

2. The toilet maintenance chatbot system of claim 1, wherein the one or more machine learning models comprise at least one natural language processing (NLP) model, and wherein the plurality of regression models comprises at least one large language model (LLM).

3. The toilet maintenance chatbot system of claim 1, wherein the instructions, when executed, further cause the system to:
based on the one or more responses not meeting the information threshold, generate, based on inputting the toilet maintenance request into the one or more machine learning models, a conversational response to elicit additional information with respect to the maintenance request.

4. The toilet maintenance chatbot system of claim 1, wherein the generating, based on inputting the toilet maintenance request into one or more machine learning models, one or more messages to identify issues with the toilet further causes the system to:
identifying one or more key words in the maintenance request; and
selecting a conversational pathway based on the one or more key words, wherein the conversational pathway comprises one or more nodes corresponding to the one or more messages.

5. The toilet maintenance chatbot system of claim 1, wherein the symptoms of the toilet comprise:
a running toilet; a leaking toilet; a clogged toilet; a damaged toilet; a broken toilet flapper; sounds noisy; smells; leaking; broken; detached; dirty; clogged; mold; mildew; need management; upkeep; damaged; missing; loose; not turning on or off; not working; not opening or closing; infestation; bad water pressure; running; and not flushing.

6. The toilet maintenance chatbot system of claim 1, wherein the generating the work order further causes the system to extract, based on the one or more responses, home profile information, wherein the home profile information comprises:
a layout of a home within which the toilet is located;
a location of the toilet within the home;
a geographic location of the home;
an identification of a type of home;
a description of equipment stored within the home; and
a description of machinery stored within the home.

7. The toilet maintenance chatbot system of claim 1, wherein instructions, when executed, further cause the system to transmit, to the technician device, the enriched work order that corresponds to the toilet maintenance request.

8. The toilet maintenance chatbot system of claim 1, wherein the enriched work order identifies:
a diagnosis of the toilet;
tools needed to fix the toilet;
parts needed to fix the toilet;
a minimum technician skill level needed to fix the toilet;
an amount of time needed to fix the toilet;
an estimated cost of fixing the toilet;
user preferences associated with fixing the toilet;
an estimated cost associated with the technician;
an estimated cost of at least one tool to fix the toilet; or
at least one part needed to fix the toilet.

9. The toilet maintenance chatbot system of claim 1, wherein the plurality of regression models comprises:
a first regression model configured to identify, based on a first named-entity recognition (NER) algorithm, the toilet and the symptoms of the toilet;
a second regression model configured to identify, based on a second NER algorithm, the location of the toilet and locations of the components of the toilet that require repair; and
a third regression model configured to further analyze an output from the first regression model and an output from the second regression model.

10. The toilet maintenance chatbot system of claim 9, wherein the output from the first regression model flows, as input, into the second regression model.

11. A toilet maintenance chatbot system comprising:
a user device;
a toilet;
a technician device; and
a computing device comprising a processor and a non-transitory memory device storing instructions that, when executed by the system, cause the system to:
receive, from the user device, a toilet maintenance request identifying issues with the toilet;
generate, based on inputting the toilet maintenance request into the one or more machine learning models, a solution to remediate the issues with the toilet;
transmit, to the user device, the solution to remediate the issues with the toilet;
receive, from the user device, one or more responses to the solution;
based on the one or more responses indicating that the solution failed, generate, based on inputting the one or more responses into the one or more machine learning models, another solution to remediate the issues with the toilet;
receive, from the user device, one or more responses to the other solution to remediate the issues with the toilet;
based on the one or more responses to the other solution indicating that the other solution failed, generate a work order that corresponds to the toilet maintenance request;
generate training data based on the work order and the one or more responses;
implement machine learning algorithms to train, using the training data, a plurality of regression models to identify a plurality of technicians;
transmit the work order to the technician device;
receive, from the technician device, feedback indicating an accuracy of the work order; and
update the plurality of regression models using the feedback.

12. The toilet maintenance chatbot system of claim 11, wherein the plurality of regression models comprises:
a first regression model configured to identify, based on a first named-entity recognition (NER) algorithm, the toilet and symptoms of the toilet;
a second regression model configured to identify, based on a second NER algorithm, a location of the toilet and locations of components of the toilet that require repair; and
a third regression model configured to further analyze an output from the first regression model and an output from the second regression model.

13. The toilet maintenance chatbot system of claim 12, wherein the output from the first regression model and the output from the second regression model further comprise:
subject matter expert classifications;
subject matter expert diagnoses; and
subject matter expert recommendations.

14. The toilet maintenance chatbot system of claim 11, wherein the instructions, when executed, further cause the system to:
based on the one or more responses not meeting the information threshold, generate, based on inputting the toilet maintenance request into the one or more machine learning models, a conversational response to elicit additional information with respect to the maintenance request.

15. The toilet maintenance chatbot system of claim 11, wherein the generating, based on inputting the toilet maintenance request into one or more machine learning models, one or more messages to identify issues with the toilet further causes the system to:
identifying one or more key words in the maintenance request; and
selecting a conversational pathway based on the one or more key words, wherein the conversational pathway comprises one or more nodes corresponding to the one or more messages.

16. A method for resolving a maintenance issue comprising:
receiving, from a user device, one or more messages comprising a maintenance request identifying a maintenance issue;
generating, based on inputting the one or more messages into one or more machine learning models, a solution to remediate the maintenance issue;
transmitting the solution to the user device;
based on receiving, from the user device, an indication that the solution failed, generating a work order that corresponds to the maintenance request;
implementing a plurality of regression models to identify a plurality of technicians to resolve the maintenance request;
transmitting the work order to a technician of the plurality of technicians;
receiving, from the technician, feedback indicating an accuracy of the work order; and
training the plurality of regression models based on the feedback.

17. The method of claim 16, wherein the plurality of regression models comprises:
a first regression model configured to identify, based on a first named-entity recognition (NER) algorithm, the maintenance issue and symptoms of the maintenance issue;
a second regression model configured to identify, based on a second NER algorithm, a location of the maintenance issue and locations of components associated with the maintenance issue that require repair; and
a third regression model configured to further analyze an output from the first regression model and an output from the second regression model,
wherein the output from the first regression model flows, as input, into the second regression model.

18. The method of claim 16, wherein the one or more machine learning models comprise at least one natural language processing (NLP) model, and wherein the plurality of regression models comprises at least one large language model (LLM).

19. The method of claim 16, further comprising:
based on the one or more responses not meeting the information threshold, generating, based on inputting the maintenance request into the one or more machine learning models, a conversational response to elicit additional information with respect to the maintenance request.

20. The method of claim 16, wherein the generating, based on inputting the maintenance request into one or more machine learning models, one or more messages to identify issues with the maintenance issue comprises:
identifying one or more key words in the maintenance request; and
selecting a conversational pathway based on the one or more key words, wherein the conversational pathway comprises one or more nodes corresponding to the one or more messages.
